(19) United States
(12) Patent Application Publication
(10) Pub. No.: US 2025/0148436 A1
(43) Pub. Date: May 8, 2025

(54) Automatically creating merchant account and enabling users to scan QRcode and make payment to unregistered merchant associated with user selected place

(71) Applicant: Yogesh Rathod, Mumbai (IN)

(72) Inventor: Yogesh Rathod, Mumbai (IN)

(21) Appl. No.: 18/848,169

(22) PCT Filed: Mar. 16, 2023
(86) PCT No.: PCT/IB2023/052562

§ 371 Date: Sep. 18, 2024

(30) Foreign Application Priority Data
Mar. 21, 2022 (WO) PCT/IB2022/052538

(51) Int. Cl. G06Q 20/08; G06Q 20/32; G06Q 20/40

(52) U.S. Cl. CPC G06Q 20/0855; G06Q 20/3276; G06Q 20/405

(57) ABSTRACT

The present disclosure relates to systems, methods, and graphical user interface for facilitates un-registered merchant in registering and creating merchant account after receiving notification regarding receiving of payments by payment service provider or server on behalf of selected place associated merchant from one or more customers. In another embodiment enabling un-registered merchant to get payment from payment hold account to merchant's bank account. In another embodiment automatically creating merchant account, notifying merchant about creation of merchant account and authorizing merchant to access merchant account, link bank account with merchant account, transfer funds from merchant account to merchant's bank account. In another embodiment facilitating users to scan QRcode and make payment to unregistered merchant associated with user selected place and enabling merchant to get payment or register, create and verify merchant account and get payment.

### FIELD OF INVENTION

The present invention relates to systems, methods, and graphical user interface for facilitates un-registered merchant in registering and creating merchant account after receiving notification regarding receiving of payments by payment service provider or server on behalf of selected place associated merchant from one or more customers. In another embodiment enabling un-registered merchant to get payment from payment hold account to merchant's bank account. In another embodiment automatically creating merchant account, notifying merchant about creation of merchant account and authorizing merchant to access merchant account, link bank account with merchant account, transfer funds from merchant account to merchant's bank account. In another embodiment facilitating users or customers in identifying current place to make payment. In another embodiment facilitating in automatically identifying and fill-up payment amount in payment interface. In another embodiment enabling collaboratively created central products catalogue, services catalogues and menu. In another embodiment enabling visually describe place including tables and seats arrangements, order and numbers.

### BACKGROUND OF THE INVENTION

At present payment platforms first need to convey merchant's to register and create merchant account for accepting payments from customers.

Present invention facilitates un-registered merchant in registering and creating merchant account after receiving one or more payments from one or more customers to hold account of payment service provider. In another embodiment enabling un-registered merchant to get payment from payment hold account to merchant's bank account. In another embodiment automatically creating merchant account, notifying merchant about creation of merchant account and authorizing merchant to access merchant account, link bank account with merchant account, transfer funds from merchant account to merchant's bank account.

Currently based on monitored and tracked location of user client device, it's difficult to identify current location associated place.

Present invention facilitating users or customers in identifying current place to make payment.

At present user need to enter payment amount for making payment.

Present invention facilitating in automatically identifying and fill-up payment amount in payment interface.

Currently place associated merchant does not providing offered products, services and menu or require to manage name and price of offered products, services and menu. Present invention enables collaboratively created central products catalogue, services catalogues and menu.

Currently place associated merchant does not able to visually and digitally identifying seat number of in-store customers to digitally identifying in-store order, providing status and notification and confirming payment. Present invention enabling visually describe place including tables and seats arrangements, order and numbers.

Therefore, it is with respect to these considerations and others that the present invention has been made.

### OBJECT OF THE INVENTION

The object of present invention is to in the event of receiving request to make payment to un-registered merchant, debit user selected payment account or payment mode and credit hold back account and notifying merchant about receiving payment from customer and facilitating merchant in creation of merchant account or providing bank details and after verification enabling merchant to transfer fund from merchant's account to bank account or directly in merchant's bank account.

The other object of present invention is automatically creating merchant accounts based on merchant associated data from one or more sources, verifying merchant and allowing merchant to access merchant account and enabling users to make payment to merchant's account.

The other object of present invention is facilitating users or customers in identifying current place to make payment.

The other object of present invention is facilitating in automatically identifying and fill-up payment amount in payment interface.

The other object of present invention is enabling collaboratively created central products catalogue, services catalogues and menu.

The other object of present invention is enabling visually describe place including tables and seats arrangements, order and numbers.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in an embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “network application” refers to a computer-based application that communicates, directly or indirectly, with at least one other component across a network. Web servers, email servers, messaging servers, and game servers are examples of network applications.

One or more embodiments described herein provide benefits and/or solve one or more of the foregoing or other problems in the art with systems and methods to:

In an embodiment generating for the place, using the hardware processor, a payment graphical user interface based on the user identity, one or more user payment accounts details including pre-set payment account, and place associated data including place identity; enabling a user, from the client computing device, to select place or location and access associated generated payment graphical user interface for entering or selecting payment amount and sending request for making payment of particular amount from the identified user payment account to the place associated merchant account; receiving, by the hardware processor, from the selected place or location associated payment graphical user interface of the client computing device, a payment request; processing, by the hardware processor, the payment request based on the received payment information without the user having to enter the account information related to merchant; determining, by the hardware processor, merchant as un-registered merchant or non-existence of merchant payment account; debiting, by the hardware processor, payment amount from the user's payment account and crediting, by the hardware processor, payment amount to the payment hold account of payment service provider or on-demand merchant account creation server; sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account; based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment; creating, by the hardware processor, merchant account; and debiting, by the hardware processor, payment amount from the payment hold account of payment service provider and crediting, by the hardware processor, payment amount to the merchant's account.

In an embodiment generating for the place, using the hardware processor, a payment graphical user interface based on the user identity, one or more user payment accounts details including pre-set payment account, and place associated data including place identity; enabling a user, from the client computing device, to select place or location and access associated generated payment graphical user interface for entering or selecting payment amount and sending request for making payment of particular amount from the identified user payment account to the place associated merchant account; receiving, by the hardware processor, from the selected place or location associated payment graphical user interface of the client computing device, a payment request; processing, by the hardware processor, the payment request based on the received payment information without the user having to enter the account information related to merchant; determining, by the hardware processor, merchant as un-registered merchant or non-existence of merchant payment account; debiting, by the hardware processor, payment amount from the user's payment account and crediting, by the hardware processor, payment amount to the payment hold account of payment service provider or on-demand merchant account creation server; sending on merchant client device, by the hardware processor, via identified place or merchant associated identified contact information including phone number and/or email address, notification including information about receiving payment from user on behalf of place associated merchant and push payment Uniform Resource Locator (URL) for enabling place associated merchant to get payment; based on selection of Uniform Resource Locator (URL), enabling place associated merchant to provide merchant payment account details including merchant bank details or debit card details for receiving payment; and debiting, by the hardware processor, payment amount from the payment hold account of payment service provider and crediting, by the hardware processor, payment amount to the merchant's account.

In an embodiment generating for the place, using the hardware processor, a payment graphical user interface based on the user identity, one or more user payment accounts details including pre-set payment account, and place associated data including place identity; enabling a user, from the client computing device, to select place or location and access associated generated payment graphical user interface for entering or selecting payment amount and sending request for making payment of particular amount from the identified user payment account to the place associated merchant account; receiving, by the hardware processor, from the selected place or location associated payment graphical user interface of the client computing device, a payment request; processing, by the hardware processor, the payment request based on the received payment information without the user having to enter the account information related to merchant; determining, by the hardware processor, merchant as un-registered merchant or non-existence of merchant payment account; sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account; based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment; creating, by the hardware processor, merchant account; and debiting, by the hardware processor, payment amount from the user's payment account and crediting, by the hardware processor, payment amount to the merchant's account.

In an embodiment generating for the place, using the hardware processor, a payment graphical user interface based on the user identity, one or more user payment accounts details including pre-set payment account, and place associated data including place identity; enabling a user, from the client computing device, to select place or location and access associated generated payment graphical user interface for entering or selecting payment amount and sending request for making payment of particular amount from the identified user payment account to the place associated merchant account; receiving, by the hardware processor, from the selected place or location associated payment graphical user interface of the client computing device, a payment request; processing, by the hardware processor, the payment request based on the received payment information without the user having to enter the account information related to merchant; determining, by the hardware processor, merchant as un-registered merchant or non-existence of merchant payment account; sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account; based on selection of Uniform Resource Locator (URL), automatically initiating, by the hardware processor, merchant payment account creation based on data from one or more sources; instructing merchant to verify and provide remaining or instructed one or more types of data including providing login information, linking merchant bank account; creating, by the hardware processor, merchant account; and debiting, by the hardware processor, payment amount from the user's payment account and crediting, by the hardware processor, payment amount to the merchant's account.

In an embodiment receiving, by the hardware processor, from the client computing device, a payment request; processing, by the hardware processor, the payment request based on the received payment information without the user having to enter the account information related to merchant; determining, by the hardware processor, merchant as un-registered merchant or non-existence of merchant payment account; debiting, by the hardware processor, payment amount from the user's payment account and crediting, by the hardware processor, payment amount to the payment hold account of payment service provider or on-demand merchant account creation server; sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account; based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment; creating, by the hardware processor, merchant account; and debiting, by the hardware processor, payment amount from the payment hold account of payment service provider and crediting, by the hardware processor, payment amount to the merchant's account.

In an embodiment receiving, by the hardware processor, from the client computing device, a payment request; processing, by the hardware processor, the payment request based on the received payment information without the user having to enter the account information related to merchant; determining, by the hardware processor, merchant as un-registered merchant or non-existence of merchant payment account; debiting, by the hardware processor, payment amount from the user's payment account and crediting, by the hardware processor, payment amount to the payment hold account of payment service provider or on-demand merchant account creation server; sending on merchant client device, by the hardware processor, via identified place or merchant associated identified contact information including phone number and/or email address, notification including information about receiving payment from user on behalf of place associated merchant and push payment Uniform Resource Locator (URL) for enabling place associated merchant to get payment; based on selection of Uniform Resource Locator (URL), enabling place associated merchant to provide merchant payment account details including merchant bank details or debit card details for receiving payment; and debiting, by the hardware processor, payment amount from the payment hold account of payment service provider and crediting, by the hardware processor, payment amount to the merchant's account.

In an embodiment receiving, by the hardware processor, from the client computing device, a payment request; processing, by the hardware processor, the payment request based on the received payment information without the user having to enter the account information related to merchant; determining, by the hardware processor, merchant as un-registered merchant or non-existence of merchant payment account; sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account; based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment; creating, by the hardware processor, merchant account; and debiting, by the hardware processor, payment amount from the user's payment account and crediting, by the hardware processor, payment amount to the merchant's account.

In an embodiment receiving, by the hardware processor, from the client computing device, a payment request; processing, by the hardware processor, the payment request based on the received payment information without the user having to enter the account information related to merchant; determining, by the hardware processor, merchant as un-registered merchant or non-existence of merchant payment account; sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account; based on selection of Uniform Resource Locator (URL), automatically initiating, by the hardware processor, merchant payment account creation based on data from one or more sources; instructing merchant to verify and provide remaining or instructed one or more types of data including providing login information, linking merchant bank account; creating, by the hardware processor, merchant account; and debiting, by the hardware processor, payment amount from the user's payment account and crediting, by the hardware processor, payment amount to the merchant's account.

In an embodiment receiving instruction from identified user for making payment to identified merchant; determining merchant is un-registered merchant or identifying non-existence of merchant's payment account; identifying merchant based on one or more types of merchant identity; automatically creating merchant account based on identified merchant related data from one or more sources; debiting payment amount from user's payment account and crediting payment amount to the merchant's account.

In an embodiment receiving instruction to make payment of particular amount to identified merchant; debiting payment amount from the user's payment account and crediting payment amount to the payment hold account of payment service provider; notifying merchant to link bank account; debiting payment amount from the payment hold account of payment service provider and crediting payment amount to the merchant's bank account.

In an embodiment receiving instruction from identified user for making payment to identified merchant; debiting payment amount from user's payment account; determining merchant is un-registered merchant or identifying non-existence of merchant's payment account; identifying merchant based on one or more types of merchant identity; automatically creating merchant account based on identified merchant related data from one or more sources; crediting payment amount to the merchant's account; after verifying merchant including merchant's identity, address, bank account, notifying and authorizing identified merchant to access merchant account including retrieve amount or transfer deposited amount from merchant account to merchant's bank account or debit card account or any payment account.

In an embodiment identifying merchant based on user selection of location or place on map, identifying or determining or selecting or providing unique name, address, email address, phone number and one or more types of identity.

In an embodiment automatically creating merchant account based on place or merchant associated data from one or more sources; verifying merchant; and allowing merchant to access merchant account and enabling users to make payment to merchant's account.

In an embodiment place or merchant associated data retrieved or accessed from one or more sources, wherein or merchant associated data comprises business databases, place on map associated data, business data including business name, address, contact information including phone number, email.

In an embodiment verifying merchant including verifying merchant's identity, phone number, address by employing one or more verification technologies.

In an embodiment notifying merchant regarding creation of merchant account, wherein notification comprises link or Uniform Resource Locator (URL) for enabling merchant to access merchant account including link bank account, request deposit(s) to confirm bank account and upload or provide additional documents or information.

In an embodiment enabling merchant to link bank account with merchant account.

In an embodiment authorizing identified merchant to access merchant account including retrieve amount or transfer amount from merchant account to merchant's bank account or any payment account.

In an embodiment enabling users to make payment from user selected payment account or payment mode to merchant's account.

In an embodiment displaying map graphical user interface to enabling user to select current location associated place or current place or select place from nearby places or select place from selected category specific nearby places or search and select place or select sub-place or select floor and select place from indoor maps or select place from list of places including favorite, liked, bookmarked, visited, transacted, plan to visit places.

In an embodiment identifying user device current location associated place or place of business or merchant based on sufficiently matching monitored and tracked current location of user client device with location information associated with the places from places database, wherein location information associated with the place comprises at least one of address, geo-coordinates or GPS coordinates, unique geo code, pre-set pointer on maps, pre-defined geofence.

In an embodiment identifying the payment account for the user comprises: identifying a plurality of payment accounts associated with a user account for the user; displaying, to the user client device, a plurality of indicators associated with the plurality of payment accounts; and receiving, from the user client device, a selected indicator from the plurality of indicators associated with the plurality of payment accounts.

In an embodiment monitoring and tracking user device current location; generating, using the hardware processor, a map, wherein the generating the map based on monitored and tracked user device current location.

In an embodiment receiving, by a hardware processor of a server coupled to a user mobile device via a network interface component and a network, location information from a user from the user mobile device; determining, by the hardware processor, one or more places that are within the threshold distance of the location provided by the user; generating, using the hardware processor, a map, wherein the generating the map based on received location information.

In an embodiment location information comprises current location, automatically determined location, selected or inputted area or suburb, city, pin code, locality, road, nearby place or point of interest, selected location on map, selected point on map, draw location on map, full or partial address and one or more type of location code.

In another embodiment receiving from a first user request to make payment of particular amount to selected first place associated merchant. Identifying selected first place associated merchant is registered or not or merchant account exist or not. In the event of identifying merchant is not registered or place associated merchant account not exist, instructing the first user to scan 1602 QRcode. Receiving from the first user, scanned QRcode data or image and place identity or the current location at the time of scan from the first user client device. Decoding received QRcode scanned data and identify one or more types of codes including Unified Payments Interface (UPI) identity (UPI ID) or Unified Payments Interface (UPI) Uniform Resource Locator (URL). Associate and store one or more types of said identified codes including Unified Payments Interface (UPI) identity (UPI ID) or Unified Payments Interface (UPI) Uniform Resource Locator (URL) which linked with bank account with said received user device current location or place identity or identified said location associated place. Receiving from a second user request to make payment of particular amount to selected first place associated merchant. Identifying selected first place associated merchant is registered or not or merchant account exist or not. In the event of identifying merchant is registered or first place associated merchant account exist, identifying associated Unified Payments Interface (UPI) identity (UPI ID) or Unified Payments Interface (UPI) Uniform Resource Locator (URL) and debiting payment of particular amount from the second user's account and crediting said payment of particular amount to said identified code or Unified Payments Interface (UPI) code or Unified Payments Interface (UPI) identity (UPI ID) or Unified Payments Interface (UPI) Uniform Resource Locator (URL) linked bank account of first place.

In another embodiment receiving from a user request to make payment of particular amount to selected first place associated merchant. Identifying selected place associated merchant is registered or not or merchant account exist or not. In the event of identifying merchant is not registered or place associated merchant account not exist, instructing the user to scan 1602 QRcode. Receiving from the user, scanned QRcode data or image and place identity or the current location at the time of scan from the user client device. Decoding received QRcode scanned data and identify one or more types of unique codes or identity(ies). Associate and store one or more types of said identified codes or identity(ies) with said received user device current location or place identity or identified said location associated place. Debiting said particular amount from user's payment account and crediting said particular amount to payment hold account of server or payment service provider. Notifying place associated merchant via place associated identified contact information including phone number or email address or message, a notification regarding creating of merchant account to receive said amount and enabling to register, create and verify merchant account and get said amount from said hold account to said created merchant account.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates a schematic diagram of an environment in which an in-store or remote payment system and merchant account creation system operates in accordance with one or more embodiments;

FIG. 2 illustrates components of an electronic device implementing various embodiments related to make payment to registered as well as un-registered merchant related to selected place on map;

FIG. 3 illustrates components of an electronic device implementing various embodiments related to receiving notification regrading receiving of payment from customer(s) and registering and creation of merchant account to get said received payments, facilitate merchant in merchant account creation, link bank account, providing bank details, accessing automatically created merchant account;

FIGS. 4-5 illustrate example graphical user interfaces for enabling user to user map application including 3^{rd} parties or external map application(s), selecting any place or current place on map, opening place associated payment graphical user interface or opening place associated payment graphical user interface via uniform resource locator (URL) and entering payment amount, selecting payment mode and requesting making payment to selected place associated registered (merchant account exist) or un-registered merchant (merchant account yet not exist) in accordance with one or more embodiments;

FIG. 6 illustrate example graphical user interfaces for enabling merchant to view received notification regarding receiving of payment on behalf of un-registered merchant and enabling merchant to create merchant account or provide bank details to receive payments or access automatically created merchant account;

FIG. 7 illustrate example graphical user interfaces for enabling un-registered and notified merchant to create business account and login information, provide business details, create and verify merchant account and link bank account to receive payments from hold account or directly from payment requested customer's payment account or payment mode;

FIGS. 8-14 illustrates flow charts describing various embodiments for facilitating unregistered merchant to register, create merchant account, link bank account, verify merchant or provide bank details to get payments paid by customers from hold account or user's payment account or access automatically created merchant account in accordance with one or more embodiments;

FIGS. 15-16 illustrate example graphical user interfaces for enabling user to identify current place for making payment to place associated merchant account in accordance with one or more embodiments;

FIG. 17 illustrates flow charts describing various embodiments for facilitating user to scan QRcode and make payment to unregistered merchant associated with user selected place and enabling merchant to get payment or register, create and verify merchant account and get payment;

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

Embodiments of the present disclosure facilitates un-registered merchant in registering and creating merchant account after receiving notification regarding receiving of payments by payment service provider or server on behalf of selected place associated merchant from one or more customers. In another embodiment enabling un-registered merchant to get payment from payment hold account to merchant's bank account. In another embodiment automatically creating merchant account, notifying merchant about creation of merchant account and authorizing merchant to access merchant account, link bank account with merchant account, transfer funds from merchant account to merchant's bank account.

In particular, one or more embodiments attracting un-registered merchant to quickly register and create merchant account or use automatically or semi-automatically created merchant account.

In another important embodiment user can make payment to registered as well as even un-registered merchant by using present invention. For example user selects place on map and select said selected place associated uniform resource locator (URL) to open payment user interface and select make payment to sending request to make payment to selected place associated merchant including un-registered merchant.

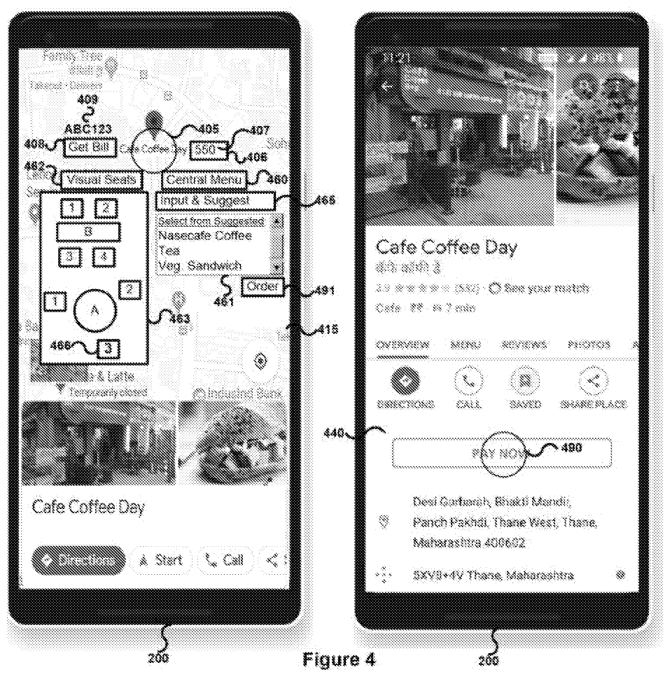

In one or more embodiments, for example, the payment system 100 receives payment request directly from user mobile device 130 at a user device location associated place and identifies merchant identity and associated merchant bank account or debit card details based on clicked place associated website or webpage or by manually inputted or selected said place associated website uniform resource locator (URL) from web browser at a checkout location and identifying the user based on received user identity or one or more types of unique identity of registered user or registered user's registered user device. As mentioned, the payment system allows users to initiate electronic payment transactions with merchants. Specifically, the payment system receives a payment request to initiate a payment transaction between a user and a merchant from a user client device. Once the payment system identifies the user, the payment system identifies a payment account for the user. For example, the payment system accesses a user account for the user and identifies a payment account. To illustrate, the payment system can identify a payment account that the user previously registered and stored in the user account. Thus, the payment system can identify the pre-set or default payment account for the user without requiring the user to perform any additional actions. FIG. 4-14 illustrates various embodiments for enabling customers or users to make payment to selected place associated unregistered merchant and enabling merchant to accept payment without first need to registering and creating merchant account.

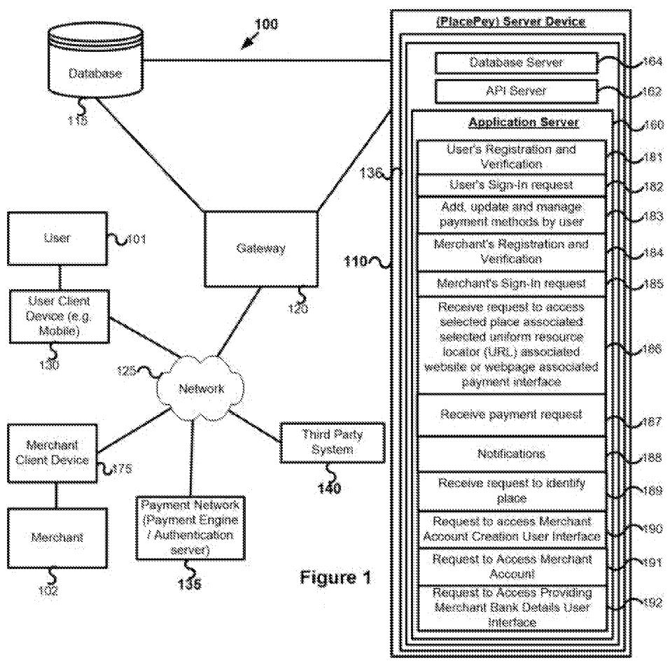

FIG. 1 is a schematic diagram illustrating an environment that includes a payment system 100 in accordance with one or more embodiments. An overview of the environment is described in relation to FIG. 1. Thereafter, a more detailed description of the components and processes of the payment system 100 and other components within the environment are provided in relation to the remaining figures.

FIG. 1 illustrates a schematic diagram illustrating additional details of the environment including the components of the payment system 100 and the payment network 135. As shown, the payment system 100 includes a user client device 130, a merchant client device 175 (collectively “client devices”), and server device(s) 110. In general, the payment system 100 allows a user associated with the user client device 130 to engage in in-store or remote electronic payment transactions with a merchant directly from user client device 130 via server 110 or one or more 3^{rd} parties payment service providers based on APIs and SDKs provided by payment system 100. Additionally, the payment system 100 can allow users to exchange messages with merchants or other users via the respective client devices.

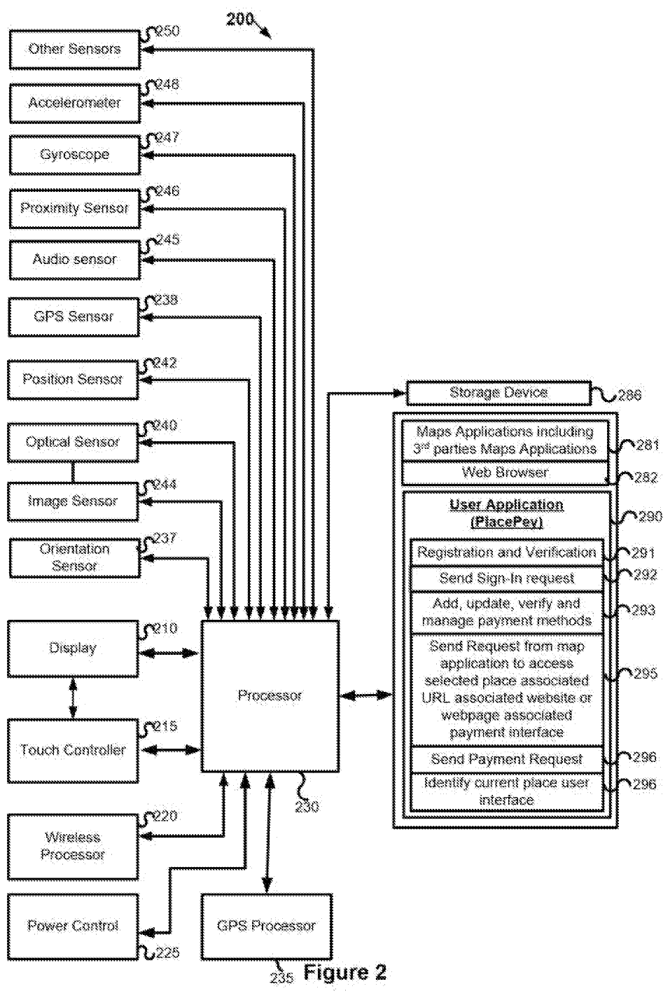

As shown, the payment system 100 includes various components on the user client device 130, the merchant client device 175, and the server device(s) 110. For example, FIG. 2 illustrates that the client devices 130 (200) and 170 (300) each include a client application (e.g., a map application, a web browser, a messaging application, a payment application) with various components, and the server device(s) 110 include a network application 160 and a payment engine 190 with various components 164/162. The merchant client device 175 (300) also includes one or more features 390. The payment network 135 is illustrated as a component or system separate from the payment system 100, though other embodiments of the payment system 100 may include some or all of the components/functionality of the payment network 135. The components of the client applications 130, 175, the network application 160, and the payment engine 190 work together to allow a user to send payments to a merchant, as described in greater detail below.

As illustrated by FIG. 1, the payment system 100 allows a user 101 to engage in electronic payment transactions with merchants. Specifically, the payment system 100 allows a user to conduct a remote or an in-store electronic payment transaction with a merchant using a user client device 130. As further illustrated in FIG. 1, and as described in more detail in additional figures, the payment system 100 allows the merchant client device 175 associated with the merchant to communicate with server device(s) 110 via a network 125. The server device(s) 110 are also able to communicate with the user client device 130 associated with the user via the network. In addition, the payment system 100 can include a payment network 135 communicatively coupled with the server device(s) 110 via the network 125. Although FIG. 1 illustrates a particular arrangement of the user client device 130, the merchant client device 175, the server device(s) 110, the network 125, and the payment network 135, various additional arrangements are possible. For example, the user client device 130 and/or the merchant client device 175 may directly communicate with the server device(s) 110, bypassing the network 125. In another example, the server device(s) 110 may include the payment network 135, such that the payment system 100 processes payment transactions at the server device(s) 110.

The payment system 100 coordinates the sending and receiving of payments between the user 101 and the merchant 102 in connection with a payment transaction.

The server device(s) 110 identifies the user based on the sign in and associated user name or one or more types of user identity and identifies the merchant based on user selected place on maps associated website or webpage uniform resource locator (URL) or web address associated merchant identity or merchant's account information including bank account or debit card details or inputted or entered or selected website or webpage uniform resource locator (URL) or web address associated merchant identity or merchant's account information including bank account or debit card details. For example, the user, using the user client device 130 can exchange payment transaction information (e.g., user/merchant identifiers, payment amounts, selected or default or pre-set payment account information) with the server device(s) 110 in one or more electronic communications. The server device(s) identifies the user 130 and merchant 175 based on the received identities and determines a payment account for the user and determines a merchant account or merchant's bank account to use in processing the payment transaction.

Additionally, the user 101, using the user client device 130, can exchange one or more electronic communications with the server device(s) 110 to confirm and authorize one or more payment transactions. For example, the server device(s) 110 can receive said payment transaction data from the user client device 130 after identifying the user 101 and merchant 102 and identifying the selected or default or pre-set payment account or automatically determined account based on charges, country, currency, offer including redeemable points and like. The user 101 can authorize the payment transaction by interacting with the user client device 130 to cause the user client device 130 to send an instruction authorization to the server device(s) 110. The server device(s) 110 can then process the payment transaction between the user 101 and the merchant 102 based on the user's authorization. Specifically, the server device(s) 110 communicate with the payment network 125 to transfer funds from a payment account of the user to a payment hold account of server or payment service provider or a payment receivable account of the merchant 175.

Based on a various embodiments of the payment system 100, the server device(s) 110 store various types of information associated with users and merchants. Specifically, the server device(s) 110 store identifier information for use in identifying the user 101 and the merchant 102 in a payment transaction. For example, in one or more embodiments, the server device(s) 106 can include or communicate with a server 110 that stores 115 user information for users registered with the server 110. To illustrate, the social networking system can maintain user accounts including user identification information and payment account information. The server device(s) 110 can use any of the user information to identify the user 101 and to initiate a payment transaction between the user 101 and a merchant 102.

FIG. 1 illustrates an example platform, under an embodiment. According to some embodiments, system 100 can be implemented through software that operates on a portable computing device, such as a mobile computing device. System 100 can be configured to communicate with one or more network services, databases, objects that coordinate, orchestrate or otherwise provide advertised contents of each user to other users of network. Additionally, the mobile computing device can integrate third-party services which enable further functionality through system 100.

While FIG. 1 illustrates a gateway 120, a database 115 and a server 110 as separate entities, the illustration is provided for example purposes only and is not meant to limit the configuration of the system. In some embodiments, gateway 120, database 115 and server 110 may be implemented in the system as separate systems, a single system, or any combination of systems.

As illustrated in FIG. 1, the system may include a user client device 130 and merchant client device 175. Devices or Mobile devices 130/175 may be particular set number of or an arbitrary number of devices or mobile devices which may be capable of accessing maps application(s), accessing web browser(s), registration, sending and receiving SMS or push notifications, send and receive user data including registration, log-in information, profile, adding of payment modes and merchant data including registration, log-in information, profile, and merchant account creation data, notifications, status, messages, contents, sign in via employing one or more methods. Each device or mobile device in the set of user and merchant) 130/175 and mobile devices 130/175 may be configured to communicate, via a wireless connection. Each one of the mobile devices 130/175 may also be configured to communicate, via a wireless connection, to a network 125, as illustrated in FIG. 1. The wireless connections of mobile devices 130/175 may be implemented within a wireless network such as a Bluetooth network or a wireless LAN.

As illustrated in FIG. 1, the system may include gateway 120. Gateway 120 may be a web gateway which may be configured to communicate with other entities of the system via wired and/or wireless network connections. As illustrated in FIG. 1, gateway 120 may communicate with mobile devices 130/175 via network 125. In various embodiments, gateway 120 may be connected to network 125 via a wired and/or wireless network connection. As illustrated in FIG. 1, gateway 120 may be connected to database 115 and server 110 of system. In various embodiments, gateway 120 may be connected to database 115 and/or server 110 via a wired or a wireless network connection.

Gateway 120 may be configured to send and receive user data including registration and profile information, payment methods, payment account and merchant account details, payment request, notifications, status, orders, payment transactions and orders logs, user shared data or contents, logs of user's activities, actions, events, senses, transactions, status, updates, presence information, locations, check-in places and like) to/from mobile devices 130/175. For example, gateway 120 may be configured to receive registration information provided by user or merchant to database 115 for storage.

Database 115 may also be configured to receive and service requests from gateway 120. For example, database 115 may receive, via gateway 120, a request from a mobile device and may service the request by providing, to gateway 120, various types of user profile, user data, added payment methods data, merchant data, logs, status which meet the criteria specified in the request. Database 115 may be configured to communicate with server 110.

As illustrated in FIG. 1, the system may include a server, such as server 110. Server may be connected to database 115 and gateway 120 via wired and/or wireless connections. As described above, server 110 may be notified, by gateway 120, of new or updated profile, payment methods, accessing of profile, user data, user payment methods, merchant data, logs and status stored in database 115.

FIG. 1 illustrates a block diagram of a system configured to implement the various embodiments related to platform. While FIG. 1 illustrates a gateway 120, a database 115 and a server 110 as separate entities, the illustration is provided for example purposes only and is not meant to limit the configuration of the system. In some embodiments, gateway 120, database 115 and server 110 may be implemented in the system as separate systems, a single system, or any combination of systems.

FIG. 2 illustrates an electronic device 200 implementing operations of the invention. In one embodiment, the electronic device 200 is a smartphone with a processor 230 in communication with a memory 290. The processor 230 may be a central processing unit and/or a graphics processing unit. The memory 290 is a combination of flash memory and random-access memory. The memory 290 stores a Registration and Verification module 291 to implement operations of one of the embodiments of the invention. Module 291 may include executable instructions to access a server which coordinates operations disclosed herein. Alternately, the module 291 may include executable instructions to coordinate some of the operations disclosed herein, while the server module 181 implements other operations. The memory 290 stores a Send Sign-In request 292 may include executable instructions to access a server which coordinates operations disclosed herein. Alternately, the module 292 may include executable instructions to coordinate some of the operations disclosed herein, while the server module 182 implements other operations. The memory 290 stores a Add, update and manage payment methods module 293 to implement operations of one of the embodiments of the invention. The module 293 may include executable instructions to access a server which coordinates operations disclosed herein. Alternately, the module 293 may include executable instructions to coordinate some of the operations disclosed herein, while the server module 183 implements other operations. The memory 290 stores a Send Request to access selected place associated selected URL associated website or webpage 295 to implement operations of one of the embodiments of the invention. The module 295 may include executable instructions to access a server which coordinates operations disclosed herein. Alternately, the module 295 may include executable instructions to coordinate some of the operations disclosed herein, while the server module 186 implements other operations. The memory 290 stores a Send Payment Request 296 to implement operations of one of the embodiments of the invention. The Send Payment Request module 296 may include executable instructions to access a server which coordinates operations disclosed herein. Alternately, the Send Payment Request module 296 may include executable instructions to coordinate some of the operations disclosed herein, while the server module 187 implements other operations. The memory 290 stores a Identify current place 296 to implement operations of one of the embodiments of the invention. The module 296 may include executable instructions to access a server which coordinates operations disclosed herein. Alternately, the module 296 may include executable instructions to coordinate some of the operations disclosed herein, while the server module 189 implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized.

The Global Positioning System (GPS) sensor 244 determines the geolocation of the mobile device 200 and generates geolocation information (e.g., coordinates including latitude, longitude, aptitude). In another embodiment, other sensors may be used to detect a geolocation of the mobile device 200. For example, a Wi-Fi sensor or Bluetooth sensor or Beacons including iBeacons or other accurate indoor or outdoor location determination and identification technologies can be used to determine the geolocation of the mobile device 200.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage device 286, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application 273, a media display application, and a media sharing application.

The storage device 286 includes a memory that may be or include flash memory, random access memory, any other type of memory accessible by the processor 230, or any suitable combination thereof. The storage device 286 stores required data received by/from application 290. The storage device 286 also stores executable instructions corresponding to Registration and Verification 291, Send Sign-In request 292, Add, update and manage payment methods 293, Send Request to access selected place associated selected URL associated website or webpage 295, Send Payment Request 296, Identify current place 296.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

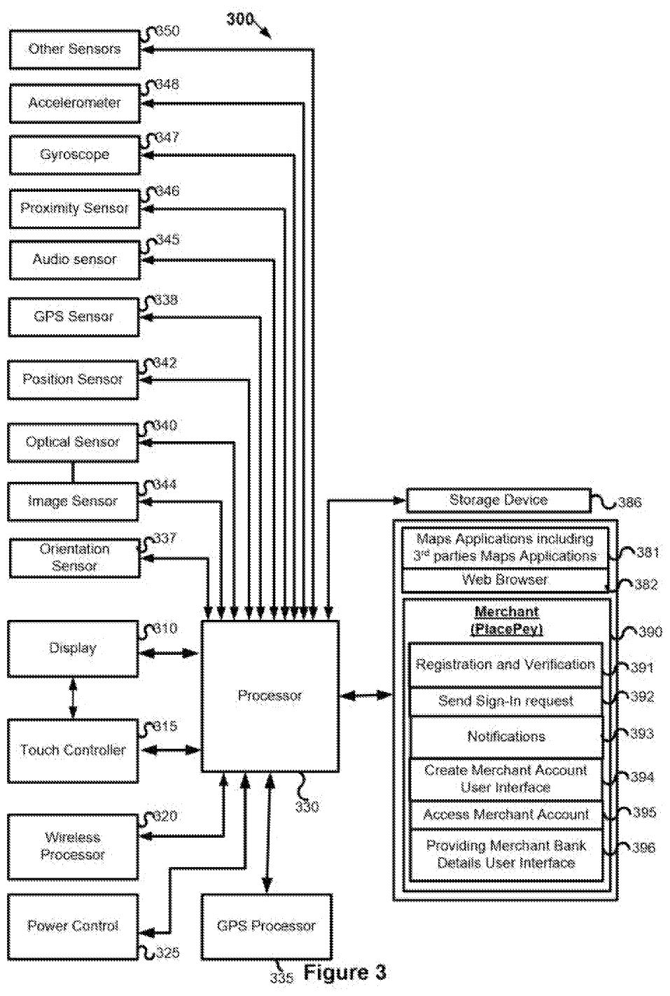

FIG. 3 illustrates an electronic device 300 implementing operations of the invention. In one embodiment, the electronic device 300 is a smartphone with a processor 230 in communication with a memory 390. The processor 330 may be a central processing unit and/or a graphics processing unit. The memory 390 is a combination of flash memory and random-access memory. The memory 390 stores a Registration and Verification module 391 to implement operations of one of the embodiments of the invention. Module 391 may include executable instructions to access a server which coordinates operations disclosed herein. Alternately, the module 391 may include executable instructions to coordinate some of the operations disclosed herein, while the server module 184 implements other operations. The memory 390 stores a Send Sign-In request 392 may include executable instructions to access a server which coordinates operations disclosed herein. Alternately, the Send Sign-In request module 392 may include executable instructions to coordinate some of the operations disclosed herein, while the server module 185 implements other operations.

The memory 390 stores a View Notifications 393 to implement operations of one of the embodiments of the invention. The module 393 may include executable instructions to access a server which coordinates operations disclosed herein. Alternately, the module 393 may include executable instructions to coordinate some of the operations disclosed herein, while the server module 188 implements other operations. The memory 390 stores a Merchant Account Creation module 394 to implement operations of one of the embodiments of the invention. The module 394 may include executable instructions to access a server which coordinates operations disclosed herein. Alternately, the module 394 may include executable instructions to coordinate some of the operations disclosed herein, while the server module 190 implements other operations. The memory 390 stores a Merchant Account Access module 395 to implement operations of one of the embodiments of the invention. The module 395 may include executable instructions to access a server which coordinates operations disclosed herein. Alternately, the module 395 may include executable instructions to coordinate some of the operations disclosed herein, while the server module 191 implements other operations. The memory 390 stores a Providing Merchant Bank Details module 396 to implement operations of one of the embodiments of the invention. The module 396 may include executable instructions to access a server which coordinates operations disclosed herein. Alternately, the module 396 may include executable instructions to coordinate some of the operations disclosed herein, while the server module 192 implements other operations.

The processor 330 is also coupled to image sensors 338. The image sensors 338 may be known digital image sensors, such as charge coupled devices. The image sensors capture visual media, which is presented on display 310. The image sensors 338 capture visual media and present the visual media on the display 310 so that a user can observe the captured visual media.

A touch controller 315 is connected to the display 310 and the processor 330. The touch controller 315 is responsive to haptic signals applied to the display 310.

The electronic device 300 may also include other components commonly associated with a smartphone, such as a wireless signal processor 320 to provide connectivity to a wireless network. A power control circuit 325 and a global positioning system (GPS) processor 335 may also be utilized.

The Global Positioning System (GPS) sensor 344 determines the geolocation of the mobile device 300 and generates geolocation information (e.g., coordinates including latitude, longitude, aptitude). In another embodiment, other sensors may be used to detect a geolocation of the mobile device 300. For example, a Wi-Fi sensor or Bluetooth sensor or Beacons including iBeacons or other accurate indoor or outdoor location determination and identification technologies can be used to determine the geolocation of the mobile device 300.

FIG. 3 shows a block diagram illustrating one example embodiment of a mobile device 300. The mobile device 300 includes an optical sensor 344 or image sensor 338, a Global Positioning System (GPS) sensor 335, a position sensor 342, a processor 330, a storage device 386, and a display 310.

The optical sensor 344 includes an image sensor 338, such as, a charge-coupled device. The optical sensor 344 captures visual media. The optical sensor 344 can be used to media items such as pictures and videos.

The GPS sensor 338 determines the geolocation of the mobile device 300 and generates geolocation information (e.g., coordinates including latitude, longitude, aptitude). In another embodiment, other sensors may be used to detect a geolocation of the mobile device 300. For example, a WiFi sensor or Bluetooth sensor or Beacons including iBeacons or other accurate indoor or outdoor location determination and identification technologies can be used to determine the geolocation of the mobile device 300.

The position sensor 342 measures a physical position of the mobile device relative to a frame of reference. For example, the position sensor 342 may include a geomagnetic field sensor to determine the direction in which the optical sensor 340 or the image sensor 344 of the mobile device is pointed and an orientation sensor 337 to determine the orientation of the mobile device (e.g., horizontal, vertical etc.).

The processor 330 may be a central processing unit that includes a media capture application 373, a media display application, and a media sharing application.

The storage device 386 includes a memory that may be or include flash memory, random access memory, any other type of memory accessible by the processor 330, or any suitable combination thereof. The storage device 386 stores required data received by/from application 390. The storage device 386 also stores executable instructions corresponding to Registration and Verification 391, Send Sign-In request 392, View Notifications 393, Merchant Account Creation module 394, Merchant Account Access module 395 and Providing Merchant Bank Details module 396.

The mobile device 300 also includes a transceiver that interfaces with an antenna. The transceiver may be configured to both transmit and receive cellular network signals, wireless data signals, or other types of signals via the antenna, depending on the nature of the mobile device 300. Further, in some configurations, the GPS sensor 338 may also make use of the antenna to receive GPS signals.

In an embodiment merchant can create new account or send registration and verification request 391 from merchant client device 300 to server 110 module 185 by providing name, mobile, email and password. Server verifies email or mobile by sending one-time password (OTP). Merchant can register with the server 110 by using online website provided by server 110 or via downloading, installing merchant's application. Server 110 displaying country specific merchant registration form based on automatically identified country or selected country. In an embodiment merchant need to enter unique place identity or unique place link or web address or uniform resource locator (URL) provided by maps including 3rd parties maps (e.g. Google Maps or Bing Maps) where said place or business is listed to identify place exists on maps including 3rd parties maps (e.g. Google Maps or Bing Maps), retrieve place associated details from listed place on maps including 3rd parties maps application (e.g. Google Maps or Bing Maps) via APIs provided by said maps including 3rd parties maps (e.g. Google Maps or Bing Maps) and check whether said place is verified or not verified on said maps including 3rd parties maps (e.g. Google Maps or Bing Maps) by using web scrapping or APIs provided by said maps including 3rd parties maps (e.g. Google Maps or Bing Maps). In an embodiment if said place is verified then automatically retrieve, import and fill maximum possible merchant's place details from maps where said place or business is listed on maps including 3rd parties maps application (e.g. Google Maps or Bing Maps) via APIs provided by said maps including 3rd parties maps (e.g. Google Maps or Bing Maps) or in another embodiment enabling merchant to manually enter or input or select details, wherein merchant's place of business details including place or business or store name, category, business details, address including shop/office number, street name, area/sector/village, pin code, city/town, state, tax identities (e.g. GST number), phone number, website, email address, position or geo-coordinates on map, photos, videos, logos, business hours, monthly turnover, country specific government identities, current payment methods used by merchant for accepting payments from customers, list and details of products and services offered including name, photo, video, description, price, quantity, offer including discount, deals. After providing place of business associated details merchant need to provide country specific merchant's bank details or provide the bank details including bank account details (e.g. Account No., IFSC Code) where merchant want to receive your money. In an embodiment verify merchant provided mobile number via one-time password (OTP). In an embodiment automatically verify said merchant's bank details, mobile number linked bank accounts or bank account linked mobile number via relevant bank APIs or one or more types of required APIs provided by authorized 3^{rd} parties. After verification merchant agree with terms and conditions and link bank account. In another embodiment server 110 match address and/or phone number linked with bank account with said provided place of business associated address and/or mobile phone number. In another embodiment server 110 generates unique payment webpage link or unique uniform resource locator (URL) or trackable unique uniform resource locator (URL) for said registered merchant based on website uniform resource locator (URL), options selected by merchant including merchant want's customer redirect to Pay-via-place payment webpage or merchant wants to integrate Pay-via-place via APIs or merchant wants to integrate link of Pay-via-place payment webpage with merchant's website or webpage to enable user to click or tap on said integrated or linked or embedded Pay-via-place link or uniform resource locator (URL) to redirect to Pay-via-place payment webpage wherein said Pay-via-place payment webpage comprise link or uniform resource locator (URL) of merchant's website's home page, so user can click on said link or uniform resource locator (URL) of merchant's website's home page to access features and contents of merchant's website. After generating said link or uniform resource locator (URL) instructing merchant to copy and paste said generated and displayed link or unique uniform resource locator (URL) or trackable unique uniform resource locator (URL) in website or URL details of listed place of business on one or more maps applications including 3rd parties maps application (e.g. Google Maps or Bing Maps), so user can click or tap on said pasted or updated or inputted or added link or uniform resource locator (URL). In an embodiment merchant can integrate Pay-via-place UI flows or pre-made UI components via Web (API) or payments APIs. Merchants can integrate with Pay-via-place as a trusted payment channel for both online and offline businesses. For Online as well as innovative offline businesses, Pay-via-place can be integrated through Web, or through mobile SDKs Android and iOS to collect payments from customers. Pay-via-place is a multi-instrument payment container and allows customers to pay through UPI, Debit Card, Credit Card, Wallet, Pay via Pay Later or Pay via Installments, Pay via store provided custom credits, Points, Crypto currencies and other payment methods and options. In another embodiment based on merchant's preferences when user click or tapped on website or URL associated or pasted in details of place of business of merchant, user is redirected to unique payment webpage of Pay-via-place, so merchant does not need to develop, maintain and host website. In another embodiment merchant can integrate said generated Pay-via-place payment webpage link or URL at the time of registration of merchant with website or webpage of merchant, so user can click or tap on said link to make payment via Pay-via-place.

In an embodiment generate QRcode for merchant for enabling their customer to pay also via scanning QR code. In an embodiment assigning a unique merchant identification number (MID) to a registered merchant account to identify it throughout the course of processing activities. In an embodiment provide API keys for integration with pay via place.

In an embodiment in API type integration a merchant submits credit card information to their own server through a form. The server then forwards the information to a pay-via-place server 110 or own payment gateways or integrated external payment service provider (PSP) through their API. PSPs usually provide a server-side SDK to help implement these integrations.

In link type integration when a user is about to make a payment, the merchant forwards the user to a PSP-hosted page with a form to accept credit card information. The payment info the user submits through the form will be directly passed to and processed by the PSP. The user will then be brought back to the merchant webpage to (hopefully) find the payment is complete.

In tokenization type integration a form is shown in a merchant hosted page, but it's actually served from a PSP's domain through an iframe. User's submission of card info will be directly passed to the PSP's server, and the merchant will receive a token as a result. The merchant can then verify it through their server and ask the PSP to process the payment. The point here is that most of these operations are handled by PSP's client-side SDK, which allows the merchant to process payments without touching a single digit of a user's credit card number.

Web Payments is the name of the working group at W3C trying to standardize a set of open standards payments in the browser. It is also used generally to mean the overall effort to make payments better on the web. Payment Request API is one of specifications the Web Payments Working Group has written. The API governs how a user agent (browser) can communicate with an implementation (website) to exchange payment credentials.

In an embodiment instruct merchant to download, install and register merchant application to finish registration. Merchant's mobile phone number is verified via sending or autofill one-time password (OTP).

In an embodiment registered merchant can send sign-in request 392 to server 110 module 186, server 110 module 186 authentic merchant based on login information including merchant user identity and password and in the event of successful login enable logged-in merchant view transaction logs including transaction identity, customer or user identity, reference number, date and time, amount, source details, invoice and like, view payment receipt notification and in the event of tapping on notification display payment receipt with details in web interface after each successful payments, conduct or manage settlements including transfer fund from merchant account to merchant's regular bank account, settlement reconciliation, fraud reporting, and dispute management and view reports and analytics. In an embodiment logged-in merchant can send request to view and access merchant's detail profile including place of business details (business or store or brand name, categories, logo, description, photos, videos, business hours, posts, answers of customers' queries, contact information including phone number, email address, website, URLs and like) and merchant account details (bank account or debit card details) to server 110 module 187, server 110 module 187 enables logged-in merchant to view, manage, add, update said details. In an embodiment logged-in merchant can send request to access user interface 394 for adding, updating, viewing and managing products or goods and services offered by merchant to server 110 module 188. Server 110 module 188 displaying user interface to logged-in merchant to enable said logged-in merchant to add, update, view and manage products or goods and services. In an embodiment logged-in merchant can send request to access transaction logs to server 110, server enables logged-in merchant to view transaction logs.

As discussed, the systems and components explained above with reference to FIG. 1 allow users (e.g., consumers) to easily, efficiently, and securely engage in remote as well as in-store electronic payment transactions with registered as well as un registered merchants via a payment system 100. FIGS. 4-14 illustrate example process diagrams of one or more example embodiments of processes implemented by the payment system 100 discussed above.

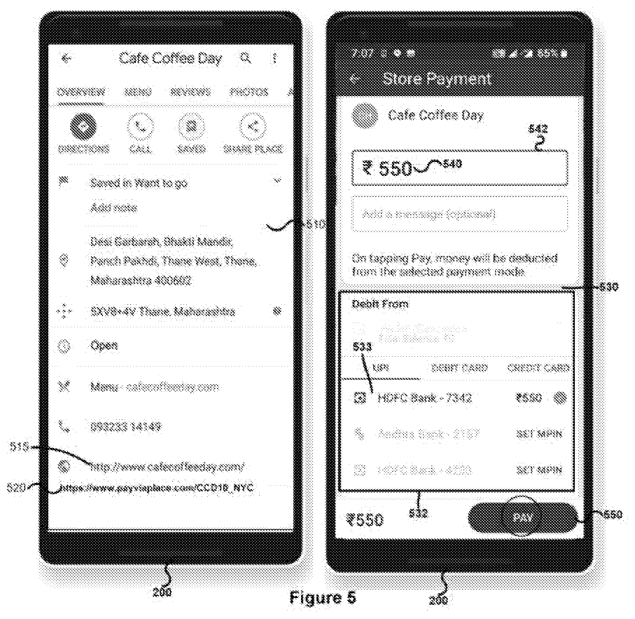

FIGS. 4-5 illustrates graphical user interface 415 of map application including 3^{rd} parties map application. In an embodiment server 110 via module 181 enabling user to registering by providing login information including user identity, password via user registration interface 291 and verify via sending one time password (OTP) or other verification technologies. Server 110 module 183 enabling user to add one or more payment accounts and modes including debit and credit cards via user interface 293. User can provide detailed profile details. In an embodiment user can use 3^{rd} parties map application and can select place and select place associated Uniform Resource Locator (URL) to open payment graphical user interface and log-in by entering user identity and password or set keep me signed in option so next time only need to select sign-in control or button to one click or one tap login. After log-in displaying payment graphical user interface or progressive web application (PWA) 530. In an embodiment identifying user device current location associated place 405 or place of business or merchant based on sufficiently matching monitored and tracked current location of user client device 200 with location information associated with the places from places database, wherein location information associated with the place comprises at least one of address, geo-coordinates or GPS coordinates, unique geo code, pre-set pointer on maps, pre-defined geofence. In an embodiment displaying map graphical user interface 415 to enabling user to select current location associated place 405 or current place or select place from nearby places or select place from selected category specific nearby places or search and select place or select sub-place or select floor and select place from indoor maps or select place from list of places including favorite, liked, bookmarked, visited, transacted, plan to visit places. Based on user selection of location or place or identifying current location of user client device, in an embodiment generating, using the hardware processor, a map 415, wherein the generated map 415 comprises plotting on the generated map 415 a selectable and actionable graphical representation or graphical indicator 405 of each identified or determined place 405 of the plurality of places on maps 415 and causing the map 415 to be displayed on a display screen of a client computing device 200. In an embodiment displaying on generated map 415, by the hardware processor via the network interface component and the network, the place associated information including selectable and actionable graphical representation or graphical indicator 405 of each identified place and associated place name 405.

In an embodiment in the event of selection of control including button 490, link or Uniform Resource Locator (URL) 515/520 or image, sending request from map application to access selected place associated Uniform Resource Locator (URL) associated website or webpage associated payment interface 295 to server 110 module 186 and displaying selected or identified place or location associated payment interface or progressive web application (PWA) 530 for enabling user to send sign-in 392 request (not shown login interface in drawings) to server module 182 and after successful login enabling user to enter amount 540 in control 542 and select control or buss ton 550 for sending payment request 296 to server 110 module 187 for, in one embodiment, making payment from user selected payment account or payment mode 533 from payment accounts 532 to directly to Uniform Resource Locator (URL) associated identified registered merchant account including merchant bank account or merchant debit card. In another embodiment in the event of selection of control including button 490, link 515/520 or image, generating for the place 405 on map 415, using the hardware processor, a payment graphical user interface or progressive web application (PWA) 530 based on the one or more place associated data including place name, place icon, user identity, user payment accounts details including pre-set payment account, place associated merchant identity and merchant account details (if merchant is registered & merchant account created or exist otherwise for making payment to unregistered merchant see details of FIGS. 4-14), wherein generated payment graphical user interface comprises the place associated details including place icon, place name, merchant account details and interfaces and controls including input or selection control or box or interface for selecting or inputting amount, user payment accounts interface for pre-set, select, add, remove and update one or more user payment accounts and control including payment button for making payment.

In an embodiment associating, using the hardware processor, the payment graphical user interface with the place on the map. In an embodiment enabling a user, from the client computing device, to select place 405 or location and access associated generated payment graphical user interface or progressive web application (PWA) 530 for entering or selecting payment amount 540 or identifying amount based on recognition of voice of user or authorized staff of place and displaying in text box 542 automatically identified amount or enable user to scan invoice or bill or receipt or label on product and get total amount based on optical character or text recognition technologies or Based on past visit associated data including amount, time, associated persons, automatically identify amount and enable user to edit amount. After entering amount, enabling user to sending request for making payment of particular amount 540 from the identified user payment account to the place associated identified merchant account including merchant bank account or merchant debit card account by selecting a payment control including button 550 or link or image. In an embodiment receiving, by the hardware processor, from the selected place 405 or location associated payment graphical user interface or progressive web application (PWA) 530 of the client computing device 560, a payment request, wherein the payment request comprises payment information including payment amount 540, identity of a user, identity of user selected or pre-set payment account to identify associated payment account information and identity of selected place on map associated merchant to identify associated merchant account information. In an embodiment processing, by the hardware processor, the payment request based on the received payment information, without the user having to enter the account information related to merchant.

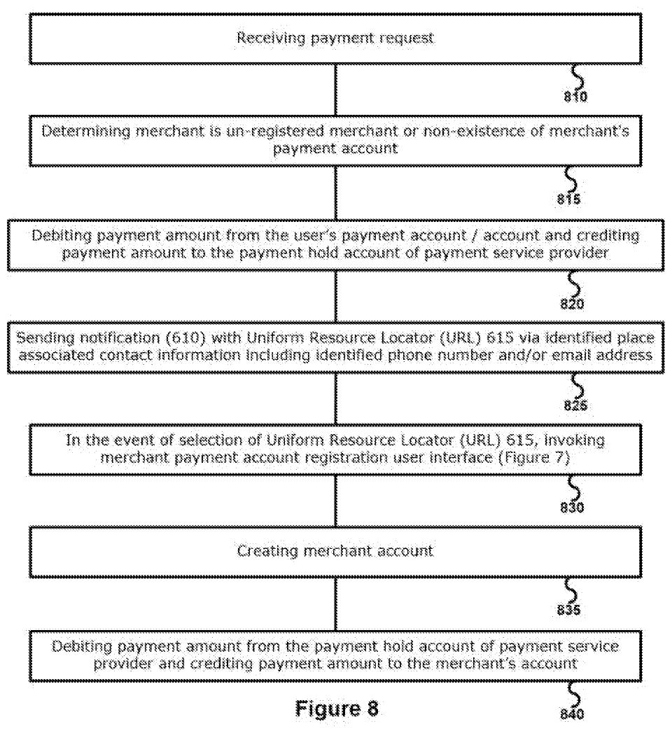

In an embodiment if merchant account exist or merchant already created merchant account then debiting, by the hardware processor, payment amount from the user's payment account and crediting, by the hardware processor, payment amount to the merchant's account including merchant bank account or debit card account. In another embodiment if merchant account does not exists or merchant yet not created merchant account then in various embodiments while sending request of making payment by selecting or clicking or tapping on control including button 550 or uniform resource locator (URL) 515/520 or name or domain name or web address or link 515/520, generating notification and sending notification via identified merchant contact information including phone number and email address, wherein in an embodiment notification including message informing said place or location associated merchant receiving of payment from customer or user from merchant's location or place (in-store payment) or from any location (remote payment) and uniform resource locator (URL) for enabling merchant to receive payment by creating merchant account or providing bank details or accessing created merchant account to transfer payment to merchant's bank account. FIGS. 8-14 discuss below in detail, various embodiments for creating merchant account.

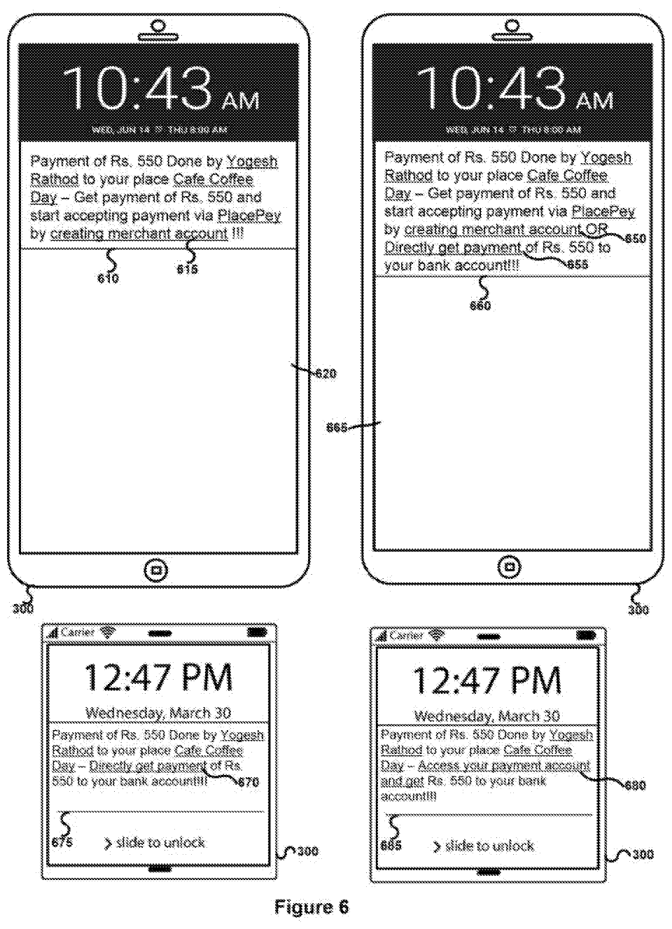

In an embodiment user using 3^{rd} parties map application when select place and then select Uniform Resource Locator (URL) 515/520 then displaying payment graphical user interface or progressive web application (PWA) 530 for enabling user to enter amount 540 in text box 542, add, update, remove, set default or select payment account 532 and make payment via selecting control or button 550 or link or image. In the event of selecting control or button 550, if system or server found that merchant account is not exist or merchant yet not registered or not created merchant account then alerting or notifying or instructing or requesting user to use separate application or progressive web application or website or webpage to send or upload screenshot or details of selected place including name, logo, address, location on map, location code, phone number, email address, website. By using dedicated application or progressive web app user can take and upload screenshot of details of selected place on map and by using payment graphical user interface or progressive web application (PWA) 530 user can enter payment amount 540 in textbox 542, add, update, remove, select or set payment account or payment mode 532 and select make payment control or button 550 to instructing server or payment service provide to make payment to selected place associated merchant. System or server identifies user identity, recognizing text inside screenshot based on employing object recognition or optical character recognition technologies, debiting user selected payment account or payment mode and as per various embodiments discussed in detail in FIGS. 6-14 crediting payment hold account then crediting created merchant account or automatically created merchant account or allow to access created merchant account and transfer fund or transfer accumulated funds related to one or more customers from merchant account to linked merchant's bank account or provided bank account details associated bank account.

In an embodiment storing in server or central database, products and services details including general or global or standard names of products, services, menu items, different types of size, shape, volume, weight, hight, measurement, numbers, color, top-in, types of different categories of products, services & menu items (master directories of products and services), wherein enabling server admins to add, modify, remove, verify or enabling users and sellers, service providers or place associated admin or staff to provide, add and submit to server one or more products, services and menu items for verification for making verified products, services and menu items available for users of network and enabling users to select place 405 from maps 415 or from list and enabling user to search, match, select one or more names of products, services, brands, and menu items 461 by in an embodiment selecting control 460 from suggested (past selection, transaction, bookmark, activities, past or current location specific), searched, bookmarked lists or one or more types of lists 461 and enabling user to input (via keyboard, voice, scan) name of products and services in input-box 465 and facilitate via automatically filled list or enable user to select from automatically suggested list based on inputted one or more characters. After selection and input of names of one or more products, services, menu items, enabling user to add to cart or order (in-store or any place online order including delivery or in-store consume or pick-up order) 491 and make payment (for online order or as per billed amount 540 after in-store consuming products & services) from user's payment account to selected place or place from map or list associated merchant's account by using selected place 405 associated payment graphical user interface 530.

In another embodiment enabling seller or service provider or place associated merchant to add, edit, remove and submit one or more added, edited and removed names of products, services, menu items related to business of merchant, related to category or domain of business to server for verification, uniqueness and make available for users of network. Authorized server admin or system automatically verifies name including uniqueness, spam, inappropriateness, spell mistake and like.

In another embodiment based on order of named of products and services by customers related to particular location or place, identifying and associating by the server system names of products and services and associated updated price, discount, offer with identified location or place to identify place associated updated sellable products and services and associated price and other details.

In another embodiment based on order of named of products and services by particular user or customer related to particular location or place, identifying and associating by the server system names of ordered products and services with identified location or place to identify place associated updated sellable products and services previously ordered by particular user or customer.

In another embodiment displaying suggested details of products and services including names of products and services and other related selections for enabling user to select one or more products and services from suggested list and also enabling user to select other selections related to selected products and services including size, shape, volume, weight, measurements, types, categories, preferences, wherein displaying suggested details of products and services including names of products and services and other related selections based on user device current location or location associated identified place, type of activity, past orders related to particular location or place.

In another embodiment displaying each selected products and services associated seller, seller details and seller associated price and enabling user to select seller or price or automatically select lowest price seller based on user setting and enabling user to make payment for ordering or purchasing selected products and services from selected sellers.

In another embodiment based on order data update inventory of seller, update user activities feed describing user's purchased products and services details related to place(s).

In another embodiment enabling place e.g. restaurants, theatre, event admin or merchant to virtually or visually draw or articulate or drag-and-drop and select, order tables and numbering seats based on visual templates including round or square tables, select number of seats to all or selected table which representing or visualizing actual physical tables and seats 463 inside particular place 405 or restaurant as per standards. So customers are enabling to select place 405 and select their current table(s) and seat(s) numbers e.g. A3 (466) from visual 2D or 3D or 4D place or restaurant 463 and enabling to identify customer to admin or staff of place or restaurant and/or enabling customer to select or input and suggest products/services 461/455 as described above and add to cart (add, modify, remove products and services one or more time before making final payment) and make order (in-store consume order or reorder or pick-up or delivery as per provided address) or enabling to reserve of book table (remotely or online as per set date and time) and/or enabling to make payment from user's payment account to selected place associated merchant's account by using selected place 305 associated payment graphical user interface 530/407. In another embodiment admin of place or restaurant can set current status of one or more tables, wherein status comprises available, occupied, soon available, time of availability, reserved or booked. In another embodiment based on customer selected table and seat number enabling staff to identify ordered items, products and services by identified customer in-store, serving order or notifying customer about status of order including time to prepare order, order ready for server or pickup, identifying payment status including payment requested, payment done, payment done, and partial payment done, notifying or providing custom offer. In another embodiment displaying photo of customer with selected number based on selector customer's identity and In another embodiment enabling admin to correct seat number based on based on displayed customer's photo associated with seat number.

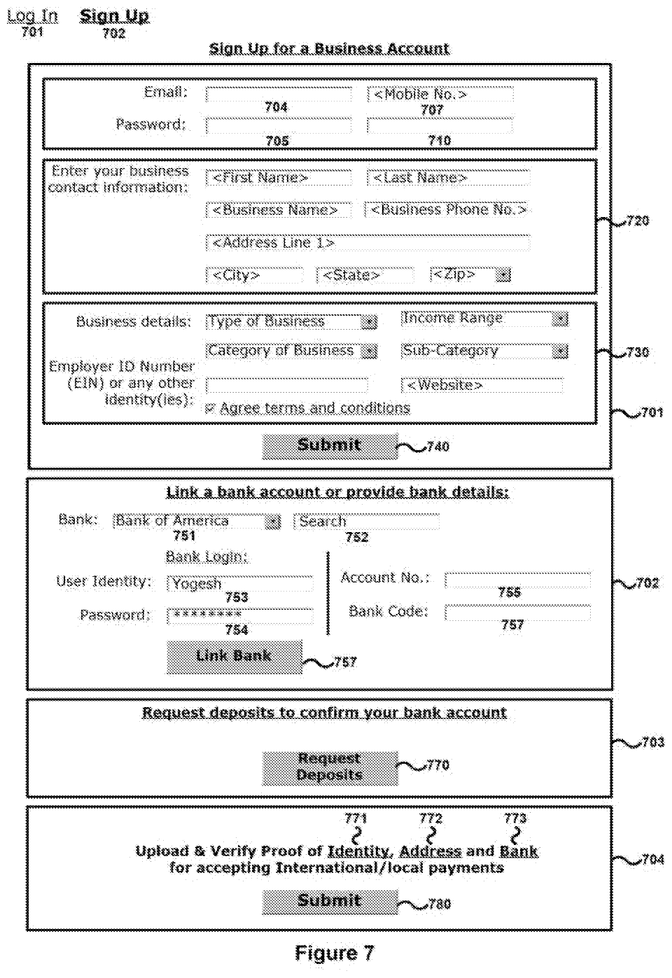

FIG. 6 illustrates graphical user interface wherein in an embodiment receiving from the client computing device 200, a payment request; debiting payment amount 540 from the user's payment account and crediting payment amount 540 to the payment hold account of payment service provider or on-demand merchant account creation server; sending by server 110 module 188 on merchant client device 300 via identified place or merchant associated identified contact information including phone number and/or email address, notification 393/610 including information about receiving payment from user on behalf of place associated merchant and merchant payment account registration Uniform Resource Locator (URL) 615 for enabling place associated merchant to create merchant payment account; based on selection of Uniform Resource Locator (URL) 615, invoking by, in an embodiment server 110 module 190 or in another embodiment client, merchant payment account registration user interface 394 (discussed in detail in FIG. 7) for enabling merchant to register including providing login information and business details, linking merchant bank account and verifying identity, address or place and bank of merchant based on merchant provided data and documents for enabling merchant to accept payment; creating merchant account; and debiting payment amount 540 from the payment hold account of payment service provider and crediting payment amount to the merchant's account.

In an embodiment receiving from the client computing device 200, a payment request; debiting payment amount 540 from the user's payment account and crediting payment amount 540 to the payment hold account of payment service provider or on-demand merchant account creation server; sending by server 110 module 188 on merchant client device 300 via identified place or merchant associated identified contact information including phone number and/or email address, notification 393/675 including information about receiving payment from user on behalf of place associated merchant and push payment Uniform Resource Locator (URL) for enabling place associated merchant to get payment; based on selection of Uniform Resource Locator (URL) 670, invoking by, in an embodiment server 110 module 192 or in another embodiment client, merchant payment account registration user interface 396 (discussed in detail in FIG. 7 (702)) for enabling place associated merchant to provide merchant payment account details including merchant bank details or debit card details for receiving payment; and debiting payment amount 540 from the payment hold account of payment service provider and crediting payment amount 540 to the merchant's account.

In an embodiment receiving instruction from identified user from client device 540 for making payment 540 to identified merchant including selected or identified place 405 on map associated merchant; debiting payment amount 540 from user's payment account; identifying merchant based on one or more types of merchant identity; automatically creating merchant account based on identified merchant related data from one or more sources; crediting payment amount to the merchant's account; after verifying merchant including merchant's identity, address, bank account, notifying 685/680 and authorizing identified merchant to access merchant account or access merchant account via Uniform Resource Locator (URL) 680 including retrieve amount or transfer deposited amount 540 from merchant account to merchant's bank account or debit card account or any payment account.

In an embodiment if merchant account exists then debiting, by the hardware processor, payment amount 540 from the user's payment account and crediting, by the hardware processor, payment amount 540 to the merchant's account including merchant bank account or debit card account.

In another embodiment user can enter amount 407 or enter amount based on user voice or use pushed amount or suggested amount and tap or long press on input-box control 406 to make payment of entered amount 407 from user selected or pre-set payment account or payment mode to said selected place 405 associated merchant's account. In another embodiment before making payment enabling user to un-do payment transaction within pre-set duration. In another embodiment identifying payment amount based on user voice or staff of place and converting voice payment amount in first language to second language and automatically input 407 or suggest user for selection payment amount. In another embodiment after successful making payment send voice notification to user an merchant and in another embodiment automatically play voice notification describing debiting or crediting payment amount or purchase of products and/or services details or describing transaction.

In an embodiment enabling user to send notification by selecting control or button 408 to selected place 405 associated merchant or request merchant to provide one or more types of details including bill or invoice or amount or other required or selected one or more types of details regarding current transaction or purchase of products and services, wherein send notification via one or more communication channels or mode or mediums including push notification, in-app message, message via messenger, SMS, E-mail, phone. Merchant can select notification and view user's details including name, photo, phone number, automatically generated code 409, identity, table or seat number 466 or one or more types of identification and sent identified user associated details including bill or invoice or amount or other required or requested one or more types of details regarding current transaction or purchase of products and services. User can view amount in payment box 407/540 or view bill or invoice or details and can make payment of said amount to said selected place associated merchant from user's account to selected places associated identified merchant's account.

FIG. 7 illustrates graphical user interface for enabling merchant to create merchant account. Merchant can sign-up for business account and use auto-filled information or edit or provide required details including email address or user identity 704, password 705/710 to crate login-id. Merchant can enter business contact information 720 including first and last name, business name, phone number and address 720, business details including type, category, sub-category, unique identity and web site name 730. Merchant can submit 740 information to create account.

In another embodiment merchant can link bank account with merchant or business account by selecting bank name 751 or search and select bank name 752, enter user identity 753 and password 754 and link bank account 757. In another embodiment merchant can link bank account with merchant or business account by selecting bank name 751 or search and select bank name 752 an enter account number 755 and bank code 757 and link bank 757. In another embodiment after linking bank account, merchant can request deposit(s) to confirm merchant's bank account by sending one or more small deposits to merchant's bank. In another embodiment enabling merchant to upload and submit 780 one or more types of required documents or provide required details including one or more types of government and bank documents to verify merchant identity 771, phone number & address 772 or bank account 773. In another embodiment automatically verifying uploaded documents via one or more types fo APIs including bank APIs, government identity verification APIs.

In another embodiment receiving payment request from user; monitoring and tracking user device location; sending notification to selected place or location associated merchant via identified place associated contact information including phone number and email address, wherein notification comprises Uniform Resource Locator (URL) of application or progressive web application or website or web page; in the event of instilling or accessing application or progressive web application or online application, monitoring and tracking merchant device location; sufficiently matching monitored & tracked user client device location with monitored & tracked merchant client device location; in the event of matching location, mark merchant as verified merchant.

In another embodiment receiving payment request and scanned face data and/or recorded voice of merchant from user; making voice call or video call to merchant on identified place associated phone number; matching voice and/or face of merchant over call with received scanned data associated face and/or recorded voice of merchant; in the event of matching, mark merchant as verified merchant.

FIG. 8 illustrating flowchart describing in various embodiments, at step 810 receiving payment request; determining merchant is un-registered merchant or non-existence of merchant's payment account at step 815; debiting payment amount from the user's payment account/account and crediting payment amount to the payment hold account including payment hold account of payment service provider or 3^{rd} parties payment service provider at step 820; sending notification with Uniform Resource Locator (URL) via identified place or location or merchant associated contact information including identified phone number and/or email address to client device of merchant at step 825; In the event of selection of Uniform Resource Locator (URL), invoking merchant payment account registration user interface (discussed in detail in FIG. 7) at step 830; based on received information from merchant, creating merchant account step 835 and debiting payment amount from the payment hold account including payment hold account of payment service provider and crediting payment amount to the merchant's account.

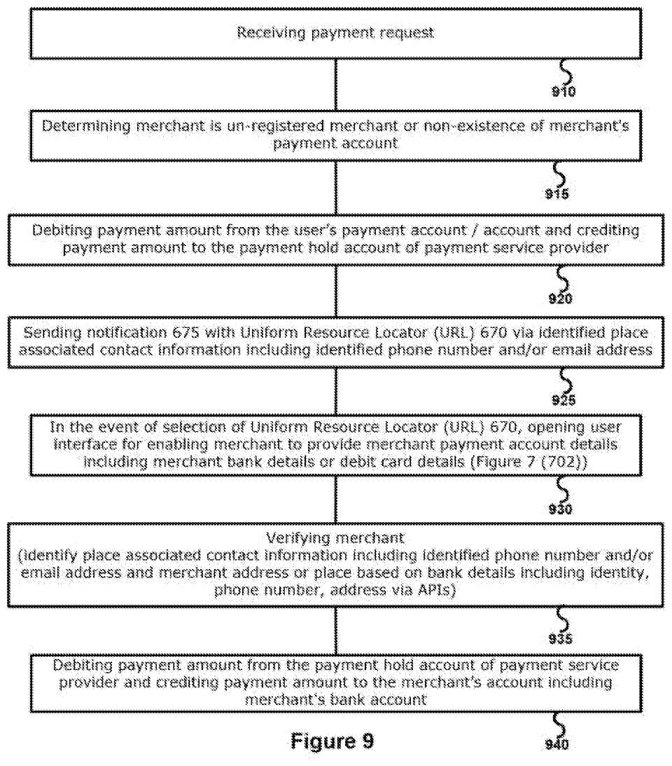

FIG. 9 illustrating flowchart describing in various embodiments, at step 910 receiving payment request; determining merchant is un-registered merchant or non-existence of merchant's payment account at step 915; debiting payment amount from the user's payment account/account and crediting payment amount to the payment hold account including payment hold account of payment service provider or 3^{rd} parties payment service provider at step 920; sending notification with Uniform Resource Locator (URL) via identified place or location or merchant associated contact information including identified phone number and/or email address to client device of merchant at step 925; In the event of selection of Uniform Resource Locator (URL), invoking or opening graphical user interface for enabling merchant to provide merchant bank account details at step 930; at step 935 based on received merchant bank account details from merchant, verifying merchant's identity and address or place or location. In an embodiment verifying merchant's identity and address or place or location by matching selected or identified place associated identified phone number and address with merchant's bank account associated or linked phone number and address via APIs including 3^{rd} parties identity, phone number and address verification APIs. At step 940, debiting payment amount from the payment hold account including payment hold account of payment service provider and crediting payment amount to the merchant's account including merchant's bank account or debit card account.

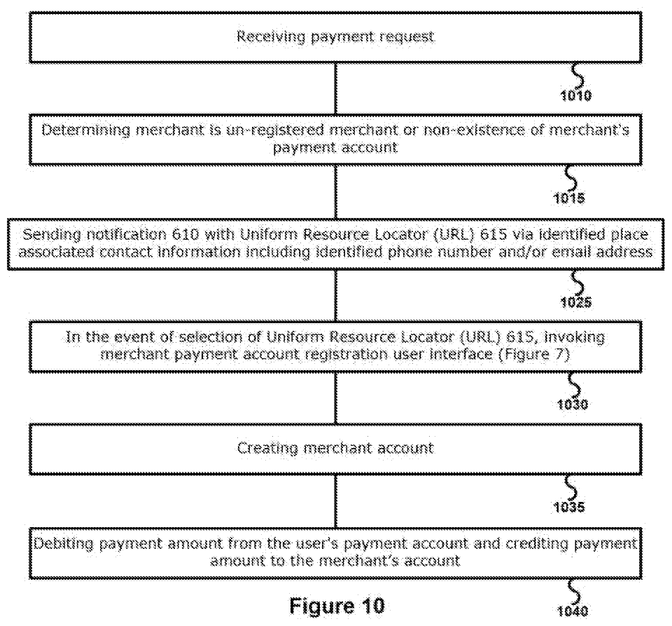

FIG. 10 illustrating flowchart describing in various embodiments, at step 1010 receiving payment request; determining merchant is un-registered merchant or non-existence of merchant's payment account at step 1015; sending notification with Uniform Resource Locator (URL) via identified place or location or merchant associated contact information including identified phone number and/or email address to client device of merchant at step 1025; In the event of selection of Uniform Resource Locator (URL), invoking merchant payment account registration user interface (discussed in detail in FIG. 7) at step 1030; based on received information from merchant, creating merchant account step 1035 and at step 1040, after successful merchant account creation, debiting payment amount from the user's payment account and crediting payment amount to the merchant's account.

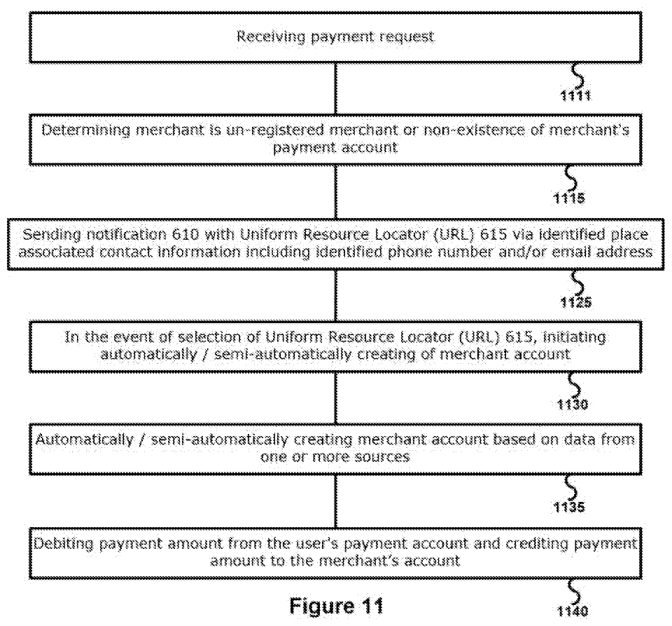

FIG. 11 illustrating flowchart describing in various embodiments, at step 1110 receiving payment request; determining merchant is un-registered merchant or non-existence of merchant's payment account at step 1115; sending notification with Uniform Resource Locator (URL) via identified place or location or merchant associated contact information including identified phone number and/or email address to client device of merchant at step 1125; In the event of selection of Uniform Resource Locator (URL), initiating automatically/semi-automatically creating of merchant account; based on user selection of place or location, identifying and retrieving place or location or associated merchant associated required one or more types of data from one or more sources and in another embodiment in the event of non-availability of one or more types of remaining data, requesting merchant to provide non-available data and creating merchant's account at step 1135 and at step 1140, after successful merchant account creation, debiting payment amount from the user's payment account and crediting payment amount to the merchant's account.

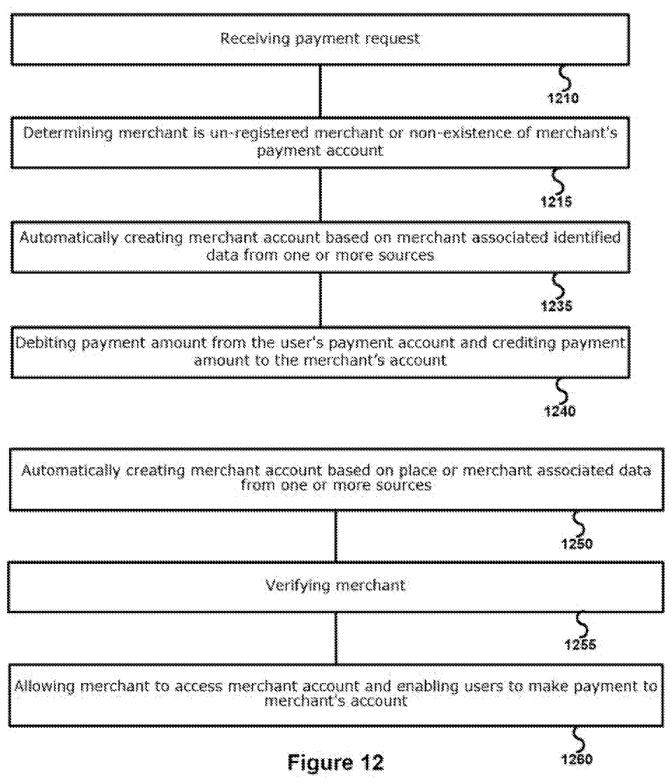

FIG. 12 illustrating flowchart describing in various embodiments, at step 1210 receiving payment request; determining merchant is un-registered merchant or non-existence of merchant's payment account at step 1215; at step 1235 automatically creating merchant account based on merchant associated identified data from one or more sources or linked system or another merchant account associated data from one or more sources or via APIs and at step 1240, after successful merchant account creation, debiting payment amount from the user's payment account and crediting payment amount to the merchant's account. In another embodiment at step 1250 automatically creating merchant account based on place or merchant associated data from one or more sources; at step 1255 verifying merchant; at step 1260 allowing merchant to access merchant account and enabling users to make payment to merchant's account.

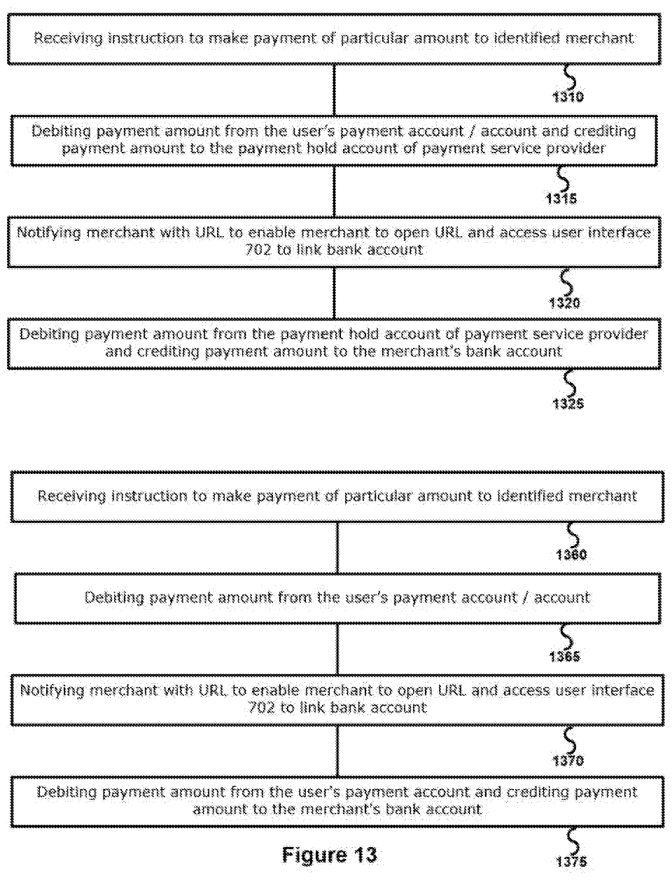

FIG. 13 illustrating flowchart describing in various embodiments, at step 1310 receiving instruction to make payment of particular amount to identified merchant; at step 1315 debiting payment amount from the user's payment account and crediting payment amount to the payment hold account of payment service provider; at step 1320 notifying merchant to link bank account; at step 1325 after successful linking of bank account, debiting payment amount from the payment hold account of payment service provider and crediting payment amount to the merchant's bank account. In another embodiment at step 1360 receiving instruction to make payment of particular amount to identified merchant; at step 1365 debiting payment amount from the user's payment account; at step 1370 notifying merchant to link bank account; at step 1375 after successful linking of bank account, debiting payment amount from the user's payment account and crediting payment amount to the merchant's bank account.

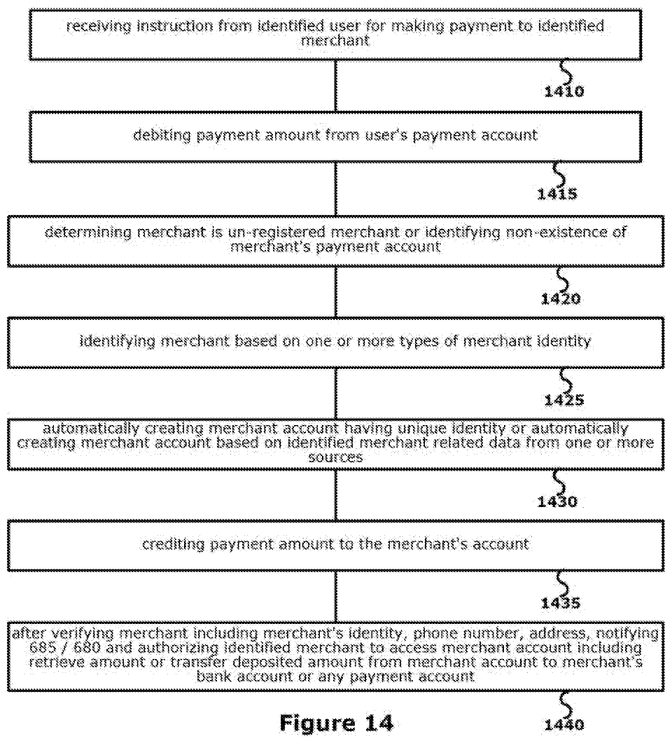

FIG. 14 illustrating flowchart describing in various embodiments, at step 1410 receiving instruction from identified user for making payment to identified merchant; debiting payment amount from user's payment account at step 1415; determining merchant is un-registered merchant or identifying non-existence of merchant's payment account at step 1420; at step 1425 identifying merchant based on one or more types of merchant identity, wherein identifying merchant based on user selection of location or place on map, identifying or determining or selecting or providing unique name, address, email address, phone number and one or more types of identity; at step 1430 automatically creating merchant account having unique identity or automatically creating merchant account based on identified merchant related data from one or more sources; at step 1435 crediting payment amount to the merchant's account; at step 1440 after verifying merchant including merchant's identity and address, notifying and authorizing identified merchant to access merchant account including retrieve amount or transfer deposited amount from said automatically created merchant account to merchant's bank account or debit card account or any payment account.

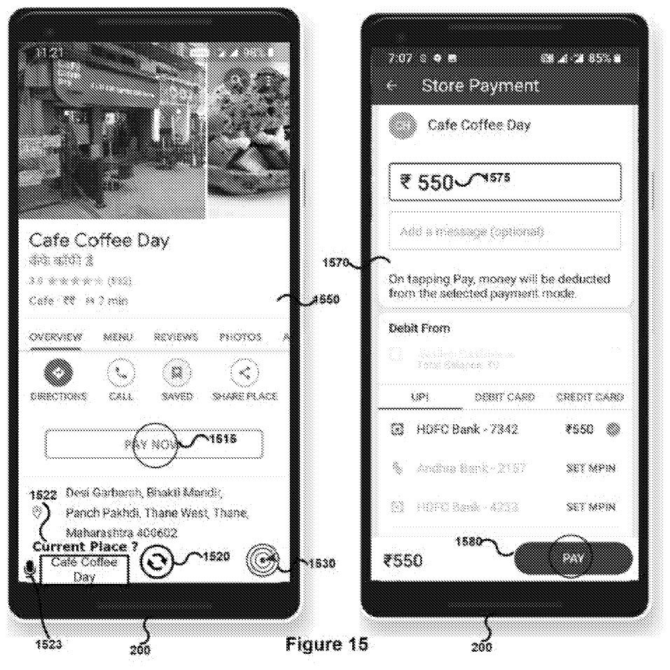

FIG. 15 illustrating graphical user interface 1550, wherein user can view user device current location associated automatically identified place based on monitored and tracked user device current location. User can view place details including place name, logo, address, and photos. User can view place on map and place surround places, distance, route details to identify current place. In another embodiment if user found that displayed place detail is not related to current place of user then user can select refresh control or button 1520 or icon or link in the event of selecting refresh control 1520, system or sever 110 module 189 suggest identify another nearest place based on past visited of places nearest to monitored and tracked user device identified current location, instructing user to select high location accuracy settings 1530. In another embodiment enabling user to enter place name and/or address 1522 or speak 1523 place name and/or address and based on entered place name and/or address or identified place name and/or address via voice enabled technologies, system or server 110 module 189 displaying identified place details 1550 or in another embodiment based on monitored and tracked current location of user client device, system or server identifies current location nearest said named or address related specific place and displaying identified place details 1550/296. In another embodiment in the event of selecting make payment request control 200 for making payment, displaying payment graphical user interface 1570 or in another embodiment displaying payment graphical user interface 1570 for enabling user to enter amount 1575, select payment account and make payment from user's payment account to said identified place associated merchant's account.

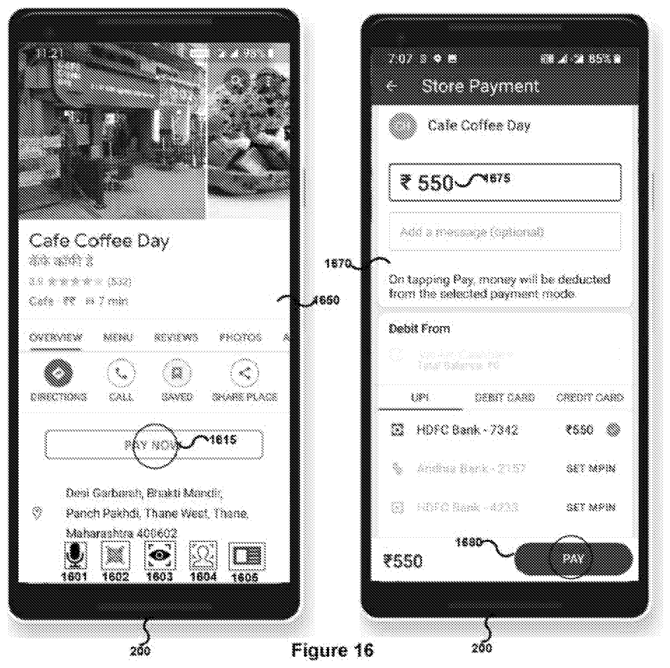

FIG. 16 illustrating graphical user interface 1650, wherein user can select option 1601 to automatically detect voice of place associated staff and based on that identify current place of user. In another embodiment user can select option 1603 to scan one or more objects related to place and based on scanned objects including logo, name, board, hording, card, menu, unique products, interior, exterior, arts, furniture, face or body of staff related to place or current place of user, system or server 110 module 189 receives said scanned objects data from user client device and matching with pre-stored place associated objects in server database and identify place or in another embodiment system or server 110 module 189 receives said scanned objects data and monitored and tracked current location of user client device from user client device and matching with pre-stored current location surround nearest places associated objects in server database and identify current place of user client device or user. After identifying current place displaying current place associated details 1650/296 so user can view place name, logo, address, photos, place on map to verify or confirm current right place. In another embodiment user can select option 1604 to scan face of staff and identify current place by matching scanned face with server pre-stored faces related to place. In another embodiment user can select option 1605 to input or speak one or more types of identity including phone number, email address, unique location id or code, brand or shop or merchant name related to current place or place associated merchant to enable server or system 110 module 189 to identify current place based on matching said unique identity with monitored and tracked user device current location related identified places associated identities and displaying identified unique current place associated details 1650/296. In another embodiment in the event of selecting make payment request control 1615 for making payment displaying payment graphical user interface 1670 or in another embodiment displaying payment graphical user interface 1670 for enabling user to enter amount 1675, select payment account and make payment from user's payment account to said identified place associated merchant's account.

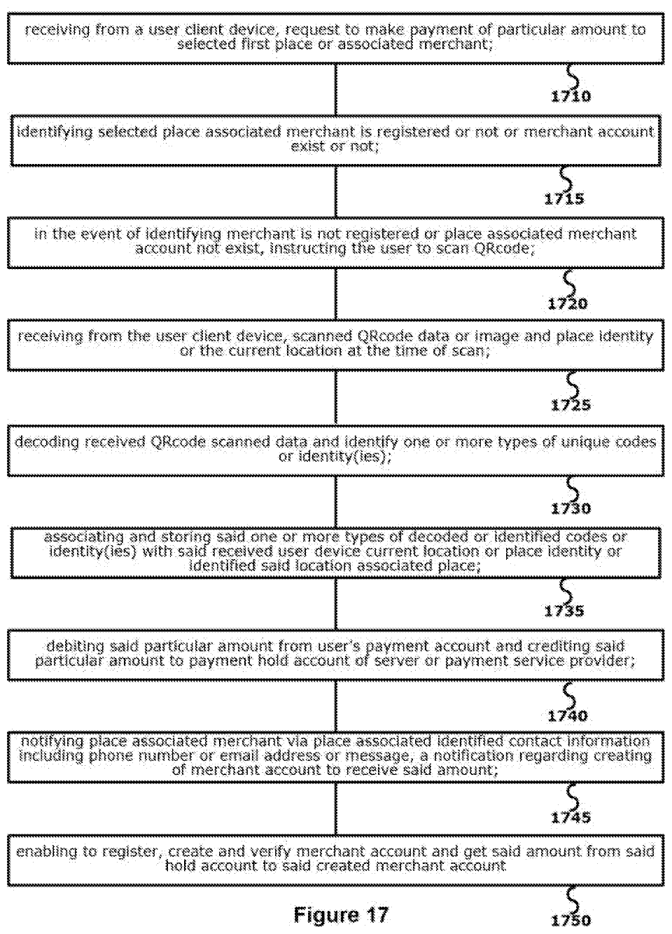

FIG. 17 illustrating flowchart describing in various embodiments, at step 1710 in another embodiment receiving from a user request to make payment of particular amount to selected first place associated merchant. At step 1715 identifying selected place associated merchant is registered or not or merchant account exist or not. At step 1720 in the event of identifying merchant is not registered or place associated merchant account not exist, instructing the user to scan 1602 QRcode. At step 1725 receiving from the user, scanned QRcode data or image and place identity or the current location at the time of scan from the user client device. At step 1730 decoding received QRcode scanned data and identify one or more types of unique codes or identity(ies). At step 1735 associating and storing one or more types of said identified codes or identity(ies) with said received user device current location or place identity or identified said location associated place. At step 1740 debiting said particular amount from user's payment account and crediting said particular amount to payment hold account of server or payment service provider. At step 1745 notifying place associated merchant via place associated identified contact information including phone number or email address or message, a notification regarding creating of merchant account to receive said amount and at step 1750 enabling to register, create and verify merchant account and get said amount from said hold account to said created merchant account. In another embodiment (not shown in figure) receiving from a first user request to make payment of particular amount to selected first place associated merchant. Identifying selected first place associated merchant is registered or not or merchant account exist or not. In the event of identifying merchant is not registered or place associated merchant account not exist, instructing the first user to scan 1602 QRcode. Receiving from the first user, scanned QRcode data or image and place identity or the current location at the time of scan from the first user client device. Decoding received QRcode scanned data and identify one or more types of codes including Unified Payments Interface (UPI) identity (UPI ID) or Unified Payments Interface (UPI) Uniform Resource Locator (URL). Associate and store one or more types of said identified codes including Unified Payments Interface (UPI) identity (UPI ID) or Unified Payments Interface (UPI) Uniform Resource Locator (URL) which linked with bank account with said received user device current location or place identity or identified said location associated place. Receiving from a second user request to make payment of particular amount to selected first place associated merchant. Identifying selected first place associated merchant is registered or not or merchant account exist or not. In the event of identifying merchant is registered or first place associated merchant account exist, identifying associated Unified Payments Interface (UPI) identity (UPI ID) or Unified Payments Interface (UPI) Uniform Resource Locator (URL) and debiting payment of particular amount from the second user's account and crediting said payment of particular amount to said identified code or Unified Payments Interface (UPI) code or Unified Payments Interface (UPI) identity (UPI ID) or Unified Payments Interface (UPI) Uniform Resource Locator (URL) linked bank account of first place.

FIGS. 18-21 illustrates example graphical user interface(s) wherein in various embodiments user can select particular place 1805 on maps 1801 and select control including button 1815/1860 from displayed user interface 1810 or place 1805 details and user actions related user interface 1850 to open or invoke visual reservation interface wherein user is enabled to visually reserve one or more tables/seats or real-time view updated tables/seats availability or send request to add walk-in queue. In another embodiment enabling user to search by providing search query(ies) 1802 and select from search results (see FIG. 19) 1955 or select one or more places 1805/1806 on maps 1801 or enabling user to select option 1901 including current location of user device 200 or provide location information including address, area, location code, suburb, zone, pin code or select location on maps 1801 and select category including restaurants or cafe to search and select user device 200 current location nearby places or user provided location information surround or nearby places from maps 1801 or search results 1955. User can select one or more places on map or searched places on map or search results 1955 and view visual reservation & walk-in queue interface 1930/1950/1980 related to each place.

In an embodiment enabling place associated registered or verified or authorized user or admin or merchant to allow to server 110 accessing of one or more in-place seating areas related camera(s) including IP cameras including allow to receive videos or video streams or image(s) at particular pre-set or default or on-demand intervals or live continuously. Server 110 receives and processes received image(s) or video(s) or video stream image(s) based on object and human or people face or body parts recognition technologies and identifies available tables/seats 1931/1936 in image(s) 1830 and displaying availability status 1931/1934 on each identified table/seat in-place including restaurant or cafe, based on linked databases displaying table booked or reserved status 1932/1933 on each identified booked or reserved table/seat and also displaying estimate time to availability of each un-available table or seat 1936/1937/1938/1939 based on monitored and tracked time starts when customers occupied table or seat and average time to eat or average time to consuming ordered items and number or persons on table, displaying place link or URL 1935 to enable user to view place details or access place interface 1850 for directions and estimate time to reach at place from current place or selected location via walk or vehicle, make call or send message, view place details including address, photos, videos, ratings, website URL or link, menu, average cost to eat per person, view timings or open or close status.

In another embodiment enabling user to apply one or more filters 1906 on all or selected search results 1955 to display search results as per applied one or more filters, herein filter comprises distance or radius or ranges of distance, place open or close status, at least availability of set number of seats or tables, type of tables, type of seats including wooden or sofa, type of place including vegetarian, kids or family or friends or couple friendly, valet parking availability, terrace or open or in-place, air-conditioner or non air-conditioner, separate private seat area, in-place washroom available, Open Now, Cuisine, Top Rated, Visited, Not Visited and like. User can provide search query 1907 or search on maps 1908/1801, select place and view place details 1909/1935, select refresh control or button 1910 to update seat availability, status, estimate time to available each seat, estimate waiting period. User can sort 1911 all or selected search results as per availability, nearest distance, budget, type of place, type of seat. User can share 1905 all or selected search results 1905 with nearby selected contacts or selected contacts from contact or connections list for getting their suggestion including enabling to select and suggest place and table(s)/seat(s). In another embodiment user can select places from search results 1955 and select book any quick available 1904 to automatically identify places and/or table(s) and/or seat(s) based on past visits of places, selected tables and seats, user device current location nearest place, liked foods, nearby user connections, preferences including budget, dishes, places, types of table and seats, type of liked food, user profile, latest availability of tables and seats of nearby place and any combination thereof. In another embodiment user can tap on displayed visual interface e.g. 1930 or select place e.g. 1930 and select reserve to open reserve interface 2010 or directly select or tap on table(s) 191 or seat(s) and book or reserve table(s) and/or seat(s) by providing number of required tables/seats and date & time details 2020. In a another embodiment user can select place 1805/1991 and select add to walk-in queue 1903 which opens user interface 2050 to enable user to provide number of persons and preferences details.

FIG. 20 illustrates graphical user interface wherein after selecting or identifying current place 2055, based on user selection of add to walk-in queue option displaying user interface 2050 to enabling user to visually select number or select number from combo-box or input number or issue voice command o input number of required table(s) and/or seat(s) or persons or use default or pre-set number and providing preferences including selected table(s) and/or seat(s), selected type of table(s) and/or seat(s), selected waiter associated table(s) and/or seat(s), type of area including open, close, rooftop, air conditioner, non-smoking area, premium, middle, side or corner table, and like. System automatically identify user identity to identify user name, photo, contact information and detailed profile. After providing details user can submit information to send request to add user in walk-in queue. User can view current number of persons in queue, estimate time of availability of required table and seats, estimate time to reach at selected place from suer device current location or from user provided location, estimate time after reaching at that selected place 2056. After receiving identified user provided information, system or server identifies user number in queue and in the event of identifying user number, sending first notification 2057 to user and displaying in user client application updated status 2056 and further sending second notification to user before pre-set duration of reaching user number in queue or reaching at particular number in queue before user's number in queue. detection of availability of table(s) based on detection of non-seating or non-identifying of humans or identifying empty or unoccupied table or human or person by employing objects including table or human or person face or body parts recognition technologies in place associated provided updated video image(s) or image(s) and identifying current number in queue as user's (Yogesh) number and associated provided or identified information, system or server 110, sending table availability notification or message 2005 or automated voice call to said queue associated identified user associated identified or provided contact information including phone number, identity and email address via message or email or automated voice call message.

After pre-set duration of interval or triggering of one or more types of events, server 110 or system updates status, action(s), information on one or more or each recognized table/seat in place (e.g. Atithi) associated updated, retrieved or identified image. Based on detection of availability of table (e.g. 5) 2065, system or server identifies current number in wait-in queue e.g. (User: Yogesh) and automatically displaying name of identified current number's associated user e.g. (User: Yogesh) 2062 and enabling user to cancel 2064 or in the event of seating by user (User: Yogesh) 2062 in automatically assigned seat (e.g. 5) 2065, server 110 or system automatically make seat as currently un-available and automatically mark seat (e.g. 5) 2065 as check-in by user (e.g. Yogesh) 2062, automatically displaying order button for enabling customer or user (User: Yogesh) 2062 to select displayed control or button 2061 for viewing place associated menu, select menu items and make order. User can always view total updated bill amount, estimated time to prepare order and waiting time after order 2063. In another embodiments enabling place admin to visually draw seat arrangements by using or drag-and-drop table, seat and number image templates or controls and based on said updated data (status, user actions and information) automatically generating and updating similar standard view 2070/2195 instead of live updated camera image view 2060 of place 2055/2190.

In another embodiment user can view place associated available seats in visual view 1930 and visit preferred place and directly seat at preferred available table 2065 at particular preferred place 2055 and manually claim table 2065 by selecting control or button 2067 and provide user identity or scan user associated QR code in user mobile device user interface or application and associate with selected table on visual view or standard view of place.

In the event of claiming table by providing user identity, server 110 or system automatically make seat as currently un-available and automatically mark seat (e.g. 5) 2065 as check-in by user (e.g. Yogesh) 2062, automatically displaying order button for enabling customer or user (User: Yogesh) 2062 to select displayed control or button 2061 for viewing place associated menu, select menu items and make order. User can always view total updated bill amount, estimated time to prepare order and waiting time after order 2063.

In another embodiment enabling user to call via phone or sent message or talk via table associated or affixed microphone to request visit personally to user's table to manually get order, provide answers or solve problems or make order via phone call or message or via table associated or affixed microphone.

In another embodiment automatically detect or identify user surround contacts via identifying user device current location associated identified place or user selected place associated client devices which are in user's connection or contact list. In an embodiment enabling user to select control or button 2072 to manually add or remove contacts who are currently participated in user's table(s) or join for consuming food or ordering of food via displayed user interface. After creating of list, users in list automatically associated with particular number table and can make order which treat as group order. At the time of making payment, any user can make payment or displaying shared bill including equal amount bill (contribution) or pre-decided percentagewise bill or as per user ordered item bill to each or group admin selected members in list of table participated members. Any member associated with table can provide rating and feedback which treat as group ratings and feedbacks.

In another embodiment user can select one or more seat(s) 2030/2032 from available seats in visual view 2010 related to particular place 2055 and can tap on table or control 2030 to open or invoke reservation interface 2020. User can provide reservation details including number of tables, seats, persons, date and time of reservation or booking and can select reserve any seat option and select reserve control or button to submit reservation request.

FIG. 21 illustrates graphical user interface or application 2192 for registered or authorized place admin or staff to access or manage full or part of real-time updated in-place camera visual view 2190 of tables & seat area of place.

System or server 110 enables place associated admin or authorized person to register and verify place and enable registered or authorized admin or staff or merchant to allow system or server 110 to access one or more camera associated video (set of images) or one or more image(s) or video stream related to seating area(a) in one or more places. System or server 110 automatically receives or receive uploaded image of seating area in each place from each place associated each camera including IP camera or digital camera after particular pre-set duration of interval (e.g. after 60 seconds). System or server 110 utilizes object recognition technologies to identify each tables/seats inside place and employs human face or body parts recognition technologies to detect each identified or recognized table associated one or more persons and associated identity and blur human faces or other objects based on privacy settings, mark table(s) in image as occupied and display name or profile link 2101 of user who booked table or system or server 110 assigned table based on walk-in queue request & current queue number(s) or manually identified user who directly seated on table, display table number 2105, order time and average time of preparation of order 2104, identify or detect table(s) without any persons seated or un-occupied table(s) and mark table in image as un-occupied or available tables 2138/2126. Based on receiving of reservation request from users, identify reserved tables and mark tables in image as reserved 2140/2137. As discussed in detail in FIG. 20 (2061), in the event of receiving order, enabling admin or authorized user or staff of place to view ordered items, connect ordered data with Point of Sale (POS) system, enabling to view bill or updated bill, view payment status and ratings, reactions and feedbacks of table associated members via admin user interface invoked by control 2102 and automatically share required order details with kitchen staff including chef(s) for instructing to prepare food and automatically or manually provide estimate time of preparing order, table associated staff including waiter(s) for notifying and instructing to serve foods as and when ready.

In another embodiment, system or server identifies time of serving foods based on recognizing food items in received updated image by using objects including food item and dish recognition technologies. In another embodiment, system or server 110 identifies time of finishing of consumption of food by table associated one or more or all users based on recognizing human body parts food consumption movement (e.g. take and eat food via hand, face chewing movement), full or empty food item dish(es) recognition technologies and identifying no any pending order and non-receiving of any order within pre-set duration. In another embodiment, system or server 110 identifies time of cleaning table after customer leaving table by recognizing identified cleaning staff of place initiating cleaning movement recognition technologies and recognizing finishing of cleaning table by non-recognition of identified cleaning staff of place. In another embodiment, system or server identifies actual persons in waiting area by calculating number of persons by using human face or body parts recognition technologies.

System or server 110 monitors and tracks various types of time including time of adding user in walk-in-queue or reservation time, time when user occupies table, time of making order, time when order is ready, time of serving order, time of making payment, time of leaving table, and non-occupied table start and end time to calculate waiting time, seating time, time user took to place order or reorder or view menu, actual time of preparing order or reorder, actual time of serving order or reorder items, identities time of finishing of consumption of food, duration of making payment after consumption of food, duration of leaving seat after making payment & reactions (ratings & feedbacks) and total time user take (seating to leaving seat) in table, time of cleaning table, time of second occupant at table after cleaning table. In another embodiment in the event of identification of more than threshold time then notifying, instructing relevant hotel staff or admin or merchant or owner or customer. For example in the event of identifying more time than threshold time in occupying table then automatically notifying customer, in making order or reorder then automatically notifying staff to manually get order or reorder, in preparing order or reorder then automatically notifying and communicating with kitchen chefs, in serving order or reorder then automatically notifying then automatically notifying waiter(s) or staff, in making payment then automatically notifying staff to visit table and manually get payment done, in leaving table then automatically notifying customer requesting to leave table for next customers, in cleaning table then automatically notifying, communicating and instructing cleaning staff to quickly clean table for next customer.

In an embodiment authorized admin can select camera 2151 and view selected camera associated seating area image view 2190 and management interface. In an embodiment authorized admin can select camera related to selected authorized place on maps 2152 and view selected camera of selected place associated seating area image view 2190 and management interface. In another embodiment authorized admin can share order 2153 with one or more persons including chefs, waiters and external food sources or aggregators via one or more communication channels. In another embodiment authorized admin can send custom offer 2154 to each customer in place, wherein custom offer comprises virtual customer card including redeemable points or general points which can used anywhere in network. Based on day, timing of day, current number of customers, user profile, admin can provide custom offer to each customer. In another embodiment authorized admin can sell products and services 2155 including products and services of 3^{rd} parties sellers which display in walk-in-queue number, place visual image in visual search, menu, beside bill, and while making payment and displaying feedback interface displaying one or more additional products and services for enabling customer to add to cart selected products and services, make payment and collect purchased products and services or instruct to send products and services on user provided delivery address. In another embodiment authorized admin can customize 2156 show/hide actions, reactions, controls, status, notifications, information on real-time updated in-place image view. In another embodiment enabling authorized admin to view various types of statistics, custom reports and data analytics 2157 including number of in-place visitors within date range, number of visits by customer seated on table, total bills within date range, most ordered or rank wise most ordered food items, average ratings, redeemable points, custom offers offered and consumed, purchased products and services. In another embodiment enabling authorized admin to communicate with selected table related selected one or more persons or staff members and other general staff via messaging, voice or video call or group call 2158.

In another embodiment enabling authorized admin to add one or more persons in walk-in queue 2159 by entering user or customer provided details including name, contact information, number of required tables/seats and preferences. In the event of identifying current number in queue related to particular customer, notifying via SMS or voice or video call or manually call and provide assigned table number information. In another embodiment enabling authorized admin to instruct authorized selected person to manually collect 2160 billed amount from particular selected table associated customer. Authorized person can view instruction in in-place visual updated view image. In another embodiment enabling authorized admin to switch 2161 from real-time updated in-place visual view image 2190 to real-time updated in-place standard view 2195 and switch from real-time updated in-place standard view 2195 to real-time updated in-place visual view 2190.

In another embodiment enabling authorized admin to view directly seated customer and in an embodiment recognizing registered customer identity based on face or body parts recognition technologies. In another embodiment in the event of receiving claiming seat information and user identity via control 2067 of user application, identifying customer and displaying customer name 2062, enable customer to make order, payment, rating 2061, enable admin to view order, payment, rating 2102, display status 2063/2104. In an embodiment in the event of non-recognition of customer or identifying non-registered user by non-recognizing customer face or non-receiving of claiming of table instruction or information from customer seated at partier seat, enabling authorized admin to select table and instructing associated order person to visit said table and get order by selecting order button 2061 in authorized order person's application or real-time updated in-place visual view image management interface and make order by adding ordered item in cart and make order or re-order, after receiving alert of finishing consumption of food, enabling order person to enter payment information and make payment 2061 and get and enter ratings & feedbacks on behalf of particular number associated un-registered customer.

In another embodiment system or server 110, recognize in-place staffs and enabling authorized admin to select one or more staff members on real-time updated in-place visual view image and select one or more type of actions including make voice or video call, send message, send order, make structured instruction including get order or payment from selected table associated customer.

In another embodiment enabling customer or user to scan particular food item which system or server 110 identifies based on object recognition technologies and enable to select rating to provide ratings, comments and reactions.

In another embodiment enabling user to set automatic payment settings wherein after identifying leaving of place and non-payment of billed amount, automatically make billed amount payment.

In another embodiment after detection of leaving of place by table associated customers or user(s), immediately recognizing objects on table including purse, beg, bottle or immediately recognizing objects on table which are other than pre-defined objects including e.g. glass, plates on table, automatically send notification to table associated person who just leave table informing them to collect their left belongings on table and pre-set hotel staff members and admins to collect customer's left belongings and label table number, so when customer came, return customer's left belongings after identifying table number based on user identity, phone number and photo.

In another embodiment after assigning particular number of table or reservation of particular number of table or directly seat on particular number of table and then changing of table, automatically identify and update table number based on human face or body parts recognition technologies or manually allow user or authorized admin to claim table and provide table number or make table as available.

In another embodiment recognizing pre-set type or pattern of human indication including thumb or 1 to five finger or thumb or 1 to five finger on food item to indicate like or 1 to 5 star, reverse thumb to indicate does not like food or any mistake in food preparation or food not prepared as per instructions.

In another embodiment after leaving place particular table customer, recognizing dishes or dish name or dish identity on table and recognizing sufficiently empty dishes or not empty dishes based on object recognition technologies and notifying in-place authorized admin or pre-set staff to investigate reasons for non-empty dishes for improvement in dishes.

In another embodiment enabling table associate customer to instruct or request to parcel remaining dish(es) by selecting control to instruct table associated staff to parcel remaining or selected dish(es).

In another embodiment enabling table person(s) to select menu by selecting customer associated table number associated control 2061 to view menus of multiple restaurants and cloud kitchens listed on multiple food delivery service providers or food aggregators and make order or reorder and make payment for ordered selected menu items of one or more restaurants and cloud kitchens or one or more restaurants and cloud kitchens listed on one or more selected food delivery service providers or food aggregators. System or server 110, sending selected food items request to corresponding selected one or more restaurants and cloud kitchens or to selected food delivery service providers or food aggregators and displaying estimated time to arrive ordered food items from each selected or one or more restaurants and cloud kitchens or to selected food delivery service providers or food aggregators, displaying maps showing delivery person's updated location with updated estimated time to arrive and displaying various types of updated status including food ordered to restaurants, cook is preparing, delivery boy picked up ordered food items and arriving to user provided or based on user device current location automatically identified place associated delivery address. In another embodiment in the event of identifying new customer in particular place, 3^{rd} parties of external restaurants and cloud kitchens or food delivery service providers or food aggregators can make one or more types of offer to customer. In another embodiment customer can reserve table as well as also order food items from one or more sources as per user provided date and time or schedule.

In another embodiment when the order is ready, based on food recognition technologies and order queue number, identifying order associated table and notifying waiter about order is ready to serve for particular table number.

In another embodiment based on table objects recognition technologies, identifying empty plates, tissue papers, table papers or cloths, napkin, empty water glass, full or empty water bottle, spoons another pre-defined standard objects are available on each un-occupied or empty table or not and are properly kept (including chairs or seats with table) or not. In the event of detection of non-availability of said pre-defined standard objects on table, notifying with photo and table number to relevant authorized person or admin.

In another embodiment based on human face and body parts recognition technologies, monitoring that table associated each waiter visited number of times to table after ordering and before leaving table by particular person(s).

In another embodiment in the event of recognizing objects including water bottle, food bowel(s) empty then notifying water to fill water bottle, food bowl(s) and like.

In another embodiment based on pre-defined voice of authorized selected staff persons, in the event of detecting conversation with customers, start recording voice and enabling admin to here conversation o enable to further suggest or provide instruction to them.

In another embodiment based on food recognition technologies, in the event of detection of less food than pre-defined threshold of food related to particular food item (i.e. detection of less food than pre-define quantity of food), notifying cook or chef or waiter or authorized persons.

In another embodiment in the event of starting preparing of ordered food items related to particular table number, enabling particular table number associated persons to live view their food preparation in kitchen by chefs and staffs in video from kitchen camera. In an embodiment particular table number associated persons can also view ordered food item(s) details including food ingredients, weight, recipe, nutrition (calorie) and health effects.

In another embodiment based on profile information of identified table(s)/seat(s) associated identified user and participated users, order details including name of item, description, identified pre-stored photos & videos and other details, payments & reactions or feedbacks details, place profile including name, photos, videos, location information and user provided photos & videos, generating posts including user photo, name, profile link, date & time, place location information, photo or video posted by user or identified photo & video of order food item or merged photo or video, identified details or user provided details or merged details, one or more user actions including like, comment, share, refer, order, reserve, sent invitation to my contacts to reserve & order, I will visit soon, participate me in next visit. In an embodiment after generating posts, displaying generated posts to user for editing posts including add or remove and replace photo or video, edit details, add or remove user actions from list of user actions, add emoticons, apply filters, edit or augment photo & video. In an embodiment user can share or publish or real-time live broadcast posts with table participated members & family members or connections of participated members, selected one or more connections on one or more selected social networks, one or more contacts and destinations and make it public or private.

In another embodiment present invention enables restaurant without kitchen and staff or less staff (automated semi-automated restaurant). In an embodiment based on online lock system, restaurant can automatically open shutter and pre-set lightings, music system, television or video on demand, and switches (as per day time or sensor detected required lightings & temperature like coolness) as per scheduled time and automatically close shutter and lightings, music system, television or video on demand and switches after recognizing no any person(s) in place via human face or body parts recognition technologies at pre-set time and schedule. As discussed above enabling customers or users to make reservation, add to walk-in queue or identify seat when user directly seat in place, after automatically or manually identifying table, enabling to order selected food items from one or more sources, make payment and provide ratings via application in customer client device. In another embodiment, after detection of eating or consumption of food, notifying customer related table associated cleaning staff or notifying customer to properly clean seat and surround area. In the event of detection of leaving of customer and non-cleaning of table, notifying customer to clean table within pre-set duration. In the event of non-cleaning of table within pre-set duration, imposing pre-set amount of penalty or additional fees or blocking of user account to block user to eating at eat places.

In another embodiment customer can view estimated time to reach at particular place or notifying customer as pre pre-set time about visiting at particular place and based on identification or determination of estimated time to reach at particular place automatically make ordered food items accordingly, so when customer reach at said particular place, ordered food is just arrived or available on reserved table.

In another embodiment enabling walking-queue customers or users to view estimated time of availability of table to user and enabling to automatically make ordered food items accordingly, so when customer's number arrived, ordered food is also arrived or available on assigned table.

In another embodiment enabling user to select contacts and send invitation and notification to selected contacts to mutually decide place including restaurant to visit, mutually decide date & time or schedule and accept or reject invitation. After mutually deciding place, date & time or schedule and accepting invitation, enabling user to instruct system to reserve number of tables/seats or reserve selected tables/seats. In another embodiment enabling each invitation accepted user to select seat and instruct system to reserve selected seat. In another embodiment enabling user to select place and select contacts and send invitation or notification (describing place name, date & time) to selected contacts and enabling contacts to accept or reject invitation. Notifying and displaying to user, accepted contacts information including name, photo, comments or special instruction and number of contacts who accepted invitation. Enabling user to instruct system to reserve number of tables/seats or reserve selected tables/seats.

In another embodiment enabling invitation sender to select food items from various sources and order food for one or more or all invitation accepted users and make payment. In another embodiment enabling each invitation accepted user to search, view, select menu of different restaurants and select and order food items deliver by corresponding restaurants or food delivery service provider. In an embodiment after making order of selected food items from preferred sources, enabling to make payment to each invitation accepted user. In another embodiment enabling invitation accepted user to select and order food items within invitation sender provided budget. In another embodiment after ordering or re-ordering of food within pre-set duration by each participant or invitation accepted users, displaying to invitation sender, total billed amount of all orders of all invitation accepted users to enable to make payments. In another embodiment notifying before pre-set duration each invitation accepted users or participants, information about date & time, place or URL of place to view place details including place name, address, photo, videos, reviews, contact information, reserved table in visual view of place, directions and route, updated estimated time to reach at place, status of ordered food delivery person on map (real-time tracking of their order status) including updated estimated time to arrive, updated location and route of ordered food delivery person on map. In another embodiment system automatically place order all order from all source such a way so each order can arrive at place as per scheduled date & time. Based on table number and seat number, delivery person put ordered food items if arrived within reserved date & time. In another embodiment, if ordered food item arrived before reserved date & time then enabling delivery person to keep ordered food items in table/seat number associated in-place locker which can open only by person who ordered food items by scanning user assigned unique code including QR code or dynamic QR code or providing biometric (fingerprint) information or scanning eye or voice command. In another embodiment enabling user to order food items from one or more sources from place and make payment. In another embodiment enabling user to select place, select food item(s) from selected source(s) and instruct to deliver said food items from selected source(s) at selected place as per rule base schedule (e.g. daily at 1 PM except Saturday and Sunday).

In another embodiment enabling system or server 110 to monitor and track each user's start and end seating time and calculate total seating time of each user and based on total seating time calculate total bill of seating time based on charges model (per visits, rule based e.g. monthly pass or subscription) and rules and automatically deduct amount from user selected or default payment method or mode. In another embodiment provide different types of cutlery packs to user based on charges model. In another embodiment provide table cleaning service to requested user. In another embodiment non-availability of balance in one or more user provided payment modes or non-payment of seating charges enabling user to pay before user's next visit else block user to reserve table or order food items.

In another embodiment based on human face or body parts recognition technologies, identifying all persons seat on table and associating and storing identities with user who reserved particular identified table or add walk-in queue and assigned particular identified table.

In another embodiment in the event of cancelling reservation or walk-in-queue, automatically make available table for others or next person in walk-in queue.

In another embodiment based on hot detection sensors, identifying ordered food's temperature and sent to relevant authorized person(s) to identify served food quality.

In another embodiment in the event of after getting order at selected place, non-attending place, further deliver ordered food item to provided delivery address including home or office address.

In another embodiment based on list of invitation accepted users or invitation sent users and provided departure address including home or office or school or college or current location or any other address, identifying most nearest place from most invitation accepted users or contacts and suggesting place to all for enabling to decide place and also for accepting invitation.

In another embodiment based on human face or body parts recognition technologies, matching currently seated person's face at particular table with reserved table number or assigned table number (in walk-in queue) associated person's photo or image and displaying table verification indication 2068 and notifying user. In another embodiment enabling order button or accepting order only after table verification. In another embodiment number affixed on table number facilitates user to identify reserved table or in walk-in queue assigned table number. In another embodiment recognizing affixed table number on table and matching with reserved table or in walk-in queue assigned table number to verify user's table number.

In another embodiment recognizing waste or fallen foods on floor surface and table surface based on waste food objects recognition technologies and automatically instructing floor surface cleaner robot to clean floor surface and automatically instructing table surface cleaner robot to clean table surface or enabling authorized admin to view floor surface and table surface and make instruction to floor surface cleaning robot to clean floor surface and instruct table surface cleaning robot to clean table surface. In another embodiment after leaving table by customer, automatically notifying and instructing customer or clean food packets from table and automictically provide instruction to table cleaner robot to clean table or notifying relevant admin, so admin can instruct table cleaner robot to clean table.

In another embodiment to get required cutlery from vending machine by making payment and after consumption of food, customer(s) or user(s) can put plates, spoons, bowls, bottle, glasses and other cutlery in automated cutlery washing system.

In another embodiment enable authorized users to scan QR code or scan face or provide voice command at entry point of place to allow to enter in place. In another embodiment automatically identify authorized user based on sufficiently matching authorized user's device current location with place location.

1-44. (canceled)

45. The computer implemented method comprising: receiving instruction from identified user for making payment to identified merchant; determining merchant is un-registered merchant or identifying non-existence of merchant's payment account; identifying merchant based on one or more types of merchant identity; automatically creating merchant account based on identified merchant related data from one or more sources; debiting payment amount from user's payment account and crediting payment amount to the merchant's account.

46. The computer implemented method of claim 45 wherein
generating for the place, using the hardware processor, a payment graphical user interface based on the user identity, one or more user payment accounts details including pre-set payment account, and place associated data including place identity;
enabling a user, from the client computing device, to select place or location and access associated generated payment graphical user interface for entering or selecting payment amount and sending request for making payment of particular amount from the identified user payment account to the place associated merchant account;
receiving, by the hardware processor, from the selected place or location associated payment graphical user interface of the client computing device, a payment request;
processing, by the hardware processor, the payment request based on the received payment information without the user having to enter the account information related to merchant;
determining, by the hardware processor, merchant as un-registered merchant or non-existence of merchant payment account;
debiting, by the hardware processor, payment amount from the user's payment account and crediting, by the hardware processor, payment amount to the payment hold account of payment service provider or on-demand merchant account creation server;
sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment;
creating, by the hardware processor, merchant account; and
debiting, by the hardware processor, payment amount from the payment hold account of payment service provider and crediting, by the hardware processor, payment amount to the merchant's account.

47. The computer implemented method of claim 45 wherein
generating for the place, using the hardware processor, a payment graphical user interface based on the user identity, one or more user payment accounts details including pre-set payment account, and place associated data including place identity;
enabling a user, from the client computing device, to select place or location and access associated generated payment graphical user interface for entering or selecting payment amount and sending request for making payment of particular amount from the identified user payment account to the place associated merchant account;
receiving, by the hardware processor, from the selected place or location associated payment graphical user interface of the client computing device, a payment request;
processing, by the hardware processor, the payment request based on the received payment information without the user having to enter the account information related to merchant;
determining, by the hardware processor, merchant as un-registered merchant or non-existence of merchant payment account;
debiting, by the hardware processor, payment amount from the user's payment account and crediting, by the hardware processor, payment amount to the payment hold account of payment service provider or on-demand merchant account creation server;
sending on merchant client device, by the hardware processor, via identified place or merchant associated identified contact information including phone number and/or email address, notification including information about receiving payment from user on behalf of place associated merchant and push payment Uniform Resource Locator (URL) for enabling place associated merchant to get payment;
based on selection of Uniform Resource Locator (URL), enabling place associated merchant to provide merchant payment account details including merchant bank details or debit card details for receiving payment; and
debiting, by the hardware processor, payment amount from the payment hold account of payment service provider and crediting, by the hardware processor, payment amount to the merchant's account.

48. The computer implemented method of claim 45 wherein
generating for the place, using the hardware processor, a payment graphical user interface based on the user identity, one or more user payment accounts details including pre-set payment account, and place associated data including place identity;
enabling a user, from the client computing device, to select place or location and access associated generated payment graphical user interface for entering or selecting payment amount and sending request for making payment of particular amount from the identified user payment account to the place associated merchant account;
receiving, by the hardware processor, from the selected place or location associated payment graphical user interface of the client computing device, a payment request;
processing, by the hardware processor, the payment request based on the received payment information without the user having to enter the account information related to merchant;
determining, by the hardware processor, merchant as un-registered merchant or non-existence of merchant payment account;
sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment;
creating, by the hardware processor, merchant account; and
debiting, by the hardware processor, payment amount from the user's payment account and crediting, by the hardware processor, payment amount to the merchant's account.

49. The computer implemented method of claim 45 wherein
generating for the place, using the hardware processor, a payment graphical user interface based on the user identity, one or more user payment accounts details including pre-set payment account, and place associated data including place identity;
enabling a user, from the client computing device, to select place or location and access associated generated payment graphical user interface for entering or selecting payment amount and sending request for making payment of particular amount from the identified user payment account to the place associated merchant account;
receiving, by the hardware processor, from the selected place or location associated payment graphical user interface of the client computing device, a payment request;
processing, by the hardware processor, the payment request based on the received payment information without the user having to enter the account information related to merchant;
determining, by the hardware processor, merchant as un-registered merchant or non-existence of merchant payment account;
sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), automatically initiating, by the hardware processor, merchant payment account creation based on data from one or more sources;
instructing merchant to verify and provide remaining or instructed one or more types of data including providing login information, linking merchant bank account;
creating, by the hardware processor, merchant account; and
debiting, by the hardware processor, payment amount from the user's payment account and crediting, by the hardware processor, payment amount to the merchant's account.

50. The computer implemented method of claim 45 wherein
receiving, by the hardware processor, from the client computing device, a payment request;
processing, by the hardware processor, the payment request based on the received payment information without the user having to enter the account information related to merchant;
determining, by the hardware processor, merchant as un-registered merchant or non-existence of merchant payment account;
debiting, by the hardware processor, payment amount from the user's payment account and crediting, by the hardware processor, payment amount to the payment hold account of payment service provider or on-demand merchant account creation server;
sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment;
creating, by the hardware processor, merchant account; and
debiting, by the hardware processor, payment amount from the payment hold account of payment service provider and crediting, by the hardware processor, payment amount to the merchant's account.

51. The computer implemented method of claim 45 wherein
receiving, by the hardware processor, from the client computing device, a payment request;
processing, by the hardware processor, the payment request based on the received payment information without the user having to enter the account information related to merchant;
determining, by the hardware processor, merchant as un-registered merchant or non-existence of merchant payment account;
debiting, by the hardware processor, payment amount from the user's payment account and crediting, by the hardware processor, payment amount to the payment hold account of payment service provider or on-demand merchant account creation server;
sending on merchant client device, by the hardware processor, via identified place or merchant associated identified contact information including phone number and/or email address, notification including information about receiving payment from user on behalf of place associated merchant and push payment Uniform Resource Locator (URL) for enabling place associated merchant to get payment;
based on selection of Uniform Resource Locator (URL), enabling place associated merchant to provide merchant payment account details including merchant bank details or debit card details for receiving payment; and
debiting, by the hardware processor, payment amount from the payment hold account of payment service provider and crediting, by the hardware processor, payment amount to the merchant's account.

52. The computer implemented method of claim 45 wherein
receiving, by the hardware processor, from the client computing device, a payment request;
processing, by the hardware processor, the payment request based on the received payment information without the user having to enter the account information related to merchant;
determining, by the hardware processor, merchant as un-registered merchant or non-existence of merchant payment account;
sending on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoking, by the hardware processor, merchant payment account registration user interface for enabling merchant to register including providing login information and business details, linking merchant bank account and verifying identity, address or place and bank of merchant based on merchant provided data and documents for enabling merchant to accept payment;
creating, by the hardware processor, merchant account; and
debiting, by the hardware processor, payment amount from the user's payment account and crediting, by the hardware processor, payment amount to the merchant's account.

53. The computer implemented method of claim 45 wherein
a) receiving from a first user client device, request to make payment of particular amount to selected first place associated merchant;
b) identifying selected first place associated merchant is registered or not or merchant account exist or not;
c) in the event of identifying merchant is not registered or place associated merchant account not exist, instructing the first user to scan QRcode;
d) receiving from the first user client device, scanned QRcode data or image and selected place associated unique identity or the current location at the time of scan;
e) decoding, by the server, said received QRcode scanned data or image and identify associated or decoded one or more types of codes including Unified Payments Interface (UPI) identity (UPI ID) or Unified Payments Interface (UPI) Uniform Resource Locator (URL);
f) associating and storing one or more types of said decoded or identified codes including Unified Payments Interface (UPI) identity (UPI ID) or Unified Payments Interface (UPI) Uniform Resource Locator (URL) which linked with bank account with said received user device current location or place identity or identified said location associated place;
g) receiving from a second user client device, request to make payment of particular amount to selected first place associated merchant;
h) identifying selected first place associated merchant is registered or not or merchant account exist or not;
i) in the event of identifying merchant is registered or first place associated merchant account exist, identifying associated Unified Payments Interface (UPI) identity (UPI ID) or Unified Payments Interface (UPI) Uniform Resource Locator (URL) and
j) debiting payment of particular amount from the second user's account and crediting said payment of particular amount to said identified code or Unified Payments Interface (UPI) code or Unified Payments Interface (UPI) identity (UPI ID) or Unified Payments Interface (UPI) Uniform Resource Locator (URL) linked bank account of first place.

54. The computer implemented method of claim 53 wherein
a) receiving from a user client device, request to make payment of particular amount to selected first place associated merchant;
b) identifying selected place associated merchant is registered or not or merchant account exist or not;
c) in the event of identifying merchant is not registered or place associated merchant account not exist, instructing the user to scan QRcode;
d) receiving from the user client device, scanned QRcode data or image and place identity or the current location at the time of scan;
e) decoding received QRcode scanned data and identify one or more types of unique codes or identity(ies);
f) associating and storing said one or more types of decoded or identified codes or identity(ies) with said received user device current location or place identity or identified said location associated place;
g) debiting said particular amount from user's payment account and crediting said particular amount to payment hold account of server or payment service provider;
h) notifying place associated merchant via place associated identified contact information including phone number or email address or message, a notification regarding creating of merchant account to receive said amount and
i) enabling to register, create and verify merchant account and get said amount from said hold account to said created merchant account.

55. The system comprising: receive instruction from identified user for making payment to identified merchant; determine merchant is un-registered merchant or identifying non-existence of merchant's payment account; identify merchant based on one or more types of merchant identity; automatically create merchant account based on identified merchant related data from one or more sources; debit payment amount from user's payment account and credit payment amount to the merchant's account.

56. The system of claim 55 wherein
a network interface component; a non-transitory memory storing instructions; and one or more hardware processors coupled to the non-transitory memory and configured to read the instructions from the non-transitory memory to cause the system to perform operations comprising:
generate for the place, using the hardware processor, a payment graphical user interface based on the user identity, one or more user payment accounts details including pre-set payment account, and place associated data including place identity;
enable a user, from the client computing device, to select place or location and access associated generated payment graphical user interface for entering or selecting payment amount and sending request for making payment of particular amount from the identified user payment account to the place associated merchant account;
receive, by the hardware processor, from the selected place or location associated payment graphical user interface of the client computing device, a payment request;
process, by the hardware processor, the payment request based on the received payment information without the user having to enter the account information related to merchant;
determine, by the hardware processor, merchant as un-registered merchant or non-existence of merchant payment account;
debit, by the hardware processor, payment amount from the user's payment account and credit, by the hardware processor, payment amount to the payment hold account of payment service provider or on-demand merchant account creation server;
send on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoke, by the hardware processor, merchant payment account registration user interface for enabling merchant to register including providing login information and business details, linking merchant bank account and verifying identity, address or place and bank of merchant based on merchant provided data and documents for enabling merchant to accept payment;
create, by the hardware processor, merchant account; and
debit, by the hardware processor, payment amount from the payment hold account of payment service provider and credit, by the hardware processor, payment amount to the merchant's account.

57. The system of claim 55 wherein
a network interface component; a non-transitory memory storing instructions; and one or more hardware processors coupled to the non-transitory memory and configured to read the instructions from the non-transitory memory to cause the system to perform operations comprising:
generate for the place, using the hardware processor, a payment graphical user interface based on the user identity, one or more user payment accounts details including pre-set payment account, and place associated data including place identity;
enable a user, from the client computing device, to select place or location and access associated generated payment graphical user interface for entering or selecting payment amount and sending request for making payment of particular amount from the identified user payment account to the place associated merchant account;
receive, by the hardware processor, from the selected place or location associated payment graphical user interface of the client computing device, a payment request;
process, by the hardware processor, the payment request based on the received payment information without the user having to enter the account information related to merchant;
determine, by the hardware processor, merchant as un-registered merchant or non-existence of merchant payment account;
debit, by the hardware processor, payment amount from the user's payment account and credit, by the hardware processor, payment amount to the payment hold account of payment service provider or on-demand merchant account creation server;
send on merchant client device, by the hardware processor, via identified place or merchant associated identified contact information including phone number and/or email address, notification including information about receiving payment from user on behalf of place associated merchant and push payment Uniform Resource Locator (URL) for enabling place associated merchant to get payment;
based on selection of Uniform Resource Locator (URL), enable place associated merchant to provide merchant payment account details including merchant bank details or debit card details for receiving payment; and
debit, by the hardware processor, payment amount from the payment hold account of payment service provider and credit, by the hardware processor, payment amount to the merchant's account.

58. The system of claim 55 wherein
a network interface component; a non-transitory memory storing instructions; and one or more hardware processors coupled to the non-transitory memory and configured to read the instructions from the non-transitory memory to cause the system to perform operations comprising:
generate for the place, using the hardware processor, a payment graphical user interface based on the user identity, one or more user payment accounts details including pre-set payment account, and place associated data including place identity;
enable a user, from the client computing device, to select place or location and access associated generated payment graphical user interface for entering or selecting payment amount and sending request for making payment of particular amount from the identified user payment account to the place associated merchant account;
receive, by the hardware processor, from the selected place or location associated payment graphical user interface of the client computing device, a payment request;
process, by the hardware processor, the payment request based on the received payment information without the user having to enter the account information related to merchant;
determine, by the hardware processor, merchant as un-registered merchant or non-existence of merchant payment account;
send on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoke, by the hardware processor, merchant payment account registration user interface for enabling merchant to register including providing login information and business details, linking merchant bank account and verifying identity, address or place and bank of merchant based on merchant provided data and documents for enabling merchant to accept payment;
create, by the hardware processor, merchant account; and
debit, by the hardware processor, payment amount from the user's payment account and credit, by the hardware processor, payment amount to the merchant's account.

59. The system of claim 55 wherein
generate for the place, using the hardware processor, a payment graphical user interface based on the user identity, one or more user payment accounts details including pre-set payment account, and place associated data including place identity;
enable a user, from the client computing device, to select place or location and access associated generated payment graphical user interface for entering or selecting payment amount and sending request for making payment of particular amount from the identified user payment account to the place associated merchant account;
receive, by the hardware processor, from the selected place or location associated payment graphical user interface of the client computing device, a payment request;
process, by the hardware processor, the payment request based on the received payment information without the user having to enter the account information related to merchant;
determine, by the hardware processor, merchant as un-registered merchant or non-existence of merchant payment account;
send on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), automatically initiate, by the hardware processor, merchant payment account creation based on data from one or more sources;
instruct merchant to verify and provide remaining or instructed one or more types of data including providing login information, linking merchant bank account;
create, by the hardware processor, merchant account; and
debit, by the hardware processor, payment amount from the user's payment account and credit, by the hardware processor, payment amount to the merchant's account.

60. The system of claim 55 wherein
receive, by the hardware processor, from the client computing device, a payment request;
process, by the hardware processor, the payment request based on the received payment information without the user having to enter the account information related to merchant;
determine, by the hardware processor, merchant as un-registered merchant or non-existence of merchant payment account;
debit, by the hardware processor, payment amount from the user's payment account and credit, by the hardware processor, payment amount to the payment hold account of payment service provider or on-demand merchant account creation server;
send on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoke, by the hardware processor, merchant payment account registration user interface for enabling merchant to register including providing login information and business details, linking merchant bank account and verifying identity, address or place and bank of merchant based on merchant provided data and documents for enabling merchant to accept payment;
create, by the hardware processor, merchant account; and
debit, by the hardware processor, payment amount from the payment hold account of payment service provider and credit, by the hardware processor, payment amount to the merchant's account.

61. The system of claim 55 wherein
receive, by the hardware processor, from the client computing device, a payment request;
process, by the hardware processor, the payment request based on the received payment information without the user having to enter the account information related to merchant;
determine, by the hardware processor, merchant as un-registered merchant or non-existence of merchant payment account;
debit, by the hardware processor, payment amount from the user's payment account and credit, by the hardware processor, payment amount to the payment hold account of payment service provider or on-demand merchant account creation server;
send on merchant client device, by the hardware processor, via identified place or merchant associated identified contact information including phone number and/or email address, notification including information about receiving payment from user on behalf of place associated merchant and push payment Uniform Resource Locator (URL) for enabling place associated merchant to get payment;
based on selection of Uniform Resource Locator (URL), enable place associated merchant to provide merchant payment account details including merchant bank details or debit card details for receiving payment; and
debit, by the hardware processor, payment amount from the payment hold account of payment service provider and credit, by the hardware processor, payment amount to the merchant's account.

62. The system of claim 55 wherein
receive, by the hardware processor, from the client computing device, a payment request;
process, by the hardware processor, the payment request based on the received payment information without the user having to enter the account information related to merchant;
determine, by the hardware processor, merchant as un-registered merchant or non-existence of merchant payment account;
send on merchant client device, by the hardware processor, via identified place or merchant associated identified contact information including phone number and/or email address, notification including information about receiving payment from user on behalf of place associated merchant and merchant payment account registration Uniform Resource Locator (URL) for enabling place associated merchant to create merchant payment account;
based on selection of Uniform Resource Locator (URL), invoke, by the hardware processor, merchant payment account registration user interface for enabling merchant to register including providing login information and business details, linking merchant bank account and verifying identity, address or place and bank of merchant based on merchant provided data and documents for enabling merchant to accept payment;
create, by the hardware processor, merchant account; and
debit, by the hardware processor, payment amount from the user's payment account and credit, by the hardware processor, payment amount to the merchant's account.

63. The system of claim 55 wherein
a) receive from a first user client device, request to make payment of particular amount to selected first place associated merchant;
b) identify selected first place associated merchant is registered or not or merchant account exist or not;
c) in the event of identifying merchant is not registered or place associated merchant account not exist, instruct the first user to scan QRcode;
d) receive from the first user client device, scanned QRcode data or image and selected place associated unique identity or the current location at the time of scan;
e) decode, by the server, said received QRcode scanned data or image and identify associated or decoded one or more types of codes including Unified Payments Interface (UPI) identity (UPI ID) or Unified Payments Interface (UPI) Uniform Resource Locator (URL);
f) associate and store one or more types of said decoded or identified codes including Unified Payments Interface (UPI) identity (UPI ID) or Unified Payments Interface (UPI) Uniform Resource Locator (URL) which linked with bank account with said received user device current location or place identity or identified said location associated place;
g) receive from a second user client device, request to make payment of particular amount to selected first place associated merchant;
h) identify selected first place associated merchant is registered or not or merchant account exist or not;
i) in the event of identify merchant is registered or first place associated merchant account exist, identify associated Unified Payments Interface (UPI) identity (UPI ID) or Unified Payments Interface (UPI) Uniform Resource Locator (URL) and
j) debit payment of particular amount from the second user's account and credit said payment of particular amount to said identified code or Unified Payments Interface (UPI) code or Unified Payments Interface (UPI) identity (UPI ID) or Unified Payments Interface (UPI) Uniform Resource Locator (URL) linked bank account of first place.

64. The system of claim 63 wherein receive from a user client device, request to make payment of particular amount to selected first place associated merchant; identify selected place associated merchant is registered or not or merchant account exist or not; in the event of identifying merchant is not registered or place associated merchant account not exist, instruct the user to scan QRcode; receive from the user client device, scanned QRcode data or image and place identity or the current location at the time of scan; decode received QRcode scanned data and identify one or more types of unique codes or identity(ies); associate and store said one or more types of decoded or identified codes or identity(ies) with said received user device current location or place identity or identified said location associated place; debit said particular amount from user's payment account and credit said particular amount to payment hold account of server or payment service provider; notify place associated merchant via place associated identified contact information including phone number or email address or message, a notification regarding creating of merchant account to receive said amount and enable to register, create and verify merchant account and get said amount from said hold account to said created merchant account.
